(19) United States
(12) Patent Application Publication
(10) Pub. No.: US 2009/0188100 A1
(43) Pub. Date: Jul. 30, 2009

(54) CHASSIS AND METHODS OF FORMING THE SAME

(75) Inventors: Max W. Durney, San Francisco, CA (US); Mario Greco, San Bruno, CA (US); Rick A. Holman, San Francisco, CA (US)

Correspondence Address: MORGAN, LEWIS & BOCKIUS, LLP, ONE MARKET SPEAR STREET TOWER, SAN FRANCISCO, CA, 94105, US

(73) Assignee: Industrial Origami, Inc., San Francisco, CA (US)

(21) Appl. No.: 12/341,998

(22) Filed: Dec. 22, 2008

Related U.S. Application Data
(60) Provisional application No. 61/016,398, filed on Dec. 21, 2007.
(60) Provisional application No. 61/087,147, filed on Aug. 7, 2008.
(60) Provisional application No. 61/087,156, filed on Aug. 7, 2008.

(51) Int. Cl. B23P 21/00; B62D 21/15

(52) U.S. Cl. 29/469; 280/781

(57) ABSTRACT

A load-bearing chassis for a motor vehicle includes a three-dimensional structure formed by a sheet of material including a plurality of bend lines. Each bend line has adjacent strap-defining structures defining a bending strap with a longitudinal strap axis oriented and positioned to extend across the bend line. Preferably the bend lines are configured and positioned to form a load-bearing chassis member when the sheet of material is bent along the bend lines. The bend lines defining geometrical features of the chassis. A method of forming the chassis is also disclosed.

### CROSS-REFERENCES TO RELATED APPLICATIONS

This application claims priority to U.S. Provisional Patent Application No. 61/087,147 filed Aug. 7, 2008, entitled CHASSIS AND METHODS OF FORMING THE SAME, the entire contents of which is incorporated herein for all purposes by this reference.

This application claims priority to U.S. Provisional Patent Application No. 61/016,398 filed Dec. 21, 2007, entitled CHASSIS AND METHODS OF FORMING THE SAME, the entire contents of which is incorporated herein for all purposes by this reference.

This application claims priority to U.S. Provisional Patent Application No. 61/087,156 filed Aug. 7, 2008, entitled METHOD FOR FORMING LAMINATE SHEET MATERIAL WITH BEND CONTROLLING STRUCTURES DEFINING A BEND LINE AND METHOD FOR FORMING THE SAME, the entire contents of which is incorporated herein for all purposes by this reference.

### FIELD OF THE INVENTION

This invention relates, in general, to chassis, and more particularly to vehicular chassis and methods for their manufacture.

### BACKGROUND OF THE INVENTION

The automotive industry has grown to become one of the largest manufacturing industries in the world. Over the years, the basic structure of the automobile has changed little. Much like other heavy machinery, automobiles still generally employ some sort of standardized chassis that supports some sort of body structure and other components and subassemblies. Such conventional chassis generally comprise numerous metal pieces connected—usually by extensive welding—into a rigidly formed frame.

Modern day automobile chassis include a structure for supporting a body or are in some way integrated with a body. Exemplars of prior art automobile chassis are U.S. Patent Publication No. 2006/0237996 to Eipper et al. (“Eipper”) and U.S. Pat. No. 4,869,539 to Cassese (“Cassese”), both of which show a motor vehicle body and supporting structure. Eipper illustrates a body and modular supporting structure formed with roof columns to support a roof module. Cassese illustrates a vehicle with front, central, and rear frames joined together by connection devices.

The modern day automobile manufacturing process has evolved around the basic chassis/body architecture. Modern assembly plants include complex manufacturing equipment to position and weld pre-formed chassis parts together. The process for manufacturing automobile chassis is generally complex, time consuming, and capital intensive. By example, the typical chassis manufacturing system requires a large number of fixtures and welding stations. The fixtures hold individual pieces or assemblies in initial geometrical locations until they are welded into position. The chassis manufacturing system, therefore, involves many complex welding and adhesive processes which require expensive equipment, highly skilled workers, and valuable assembly floor space.

The manufacturing process increases in complexity exponentially as the chassis design increases in complexity. In contrast to a simple welded box frame, a typical space frame involves joining larger, modular components. Space frames generally include castings, extrusions, and sheet materials from pressings and roll forms interconnected to form a three-dimensional frame. Space frames and body-integral designs provide certain benefits over box frames; however, such designs can only be applied at a higher cost. Because of the capital-intensive nature of the manufacturing process, many designs become unfeasible at low volumes. The nature of the structure and joining process also limits its use to substantially-uniform materials. For example, aluminum can not be worked like steel, and welding steel to aluminum is difficult at best. The large manufacturing investment necessary with conventional chassis also limits manufacturing and design flexibility.

In addition to the above problems, there is a continual need to increase the efficiency of processes for manufacturing chassis structures. It is desirable to increase the strength-to-weight ratio of chassis at the same or reduced cost. Because the chassis serves as one of the primary supporting structures, the chassis has a significant impact on the overall performance of the vehicle. As an example, a “loose” chassis that lacks rigidity may sacrifice ride comfort by transmitting vibrations from the engine, wheels, and other working parts throughout the vehicle.

There is also a need to increase space efficiency. In a typical vehicle, especially in the automotive industry, “real estate” is at a premium and there are significant benefits when any space in the chassis can be made available for other uses. In other words, chassis structures may require high strength at minimal cost in light of dimensional limitations.

Other industries with machinery employing chassis encounter similar problems as the automotive industry. By way of example, a piece of heavy construction equipment, such as a backhoe, may not be as limited in terms of space as an automobile, but the chassis will be subjected to static and dynamic loads. The chassis structure will likewise require expensive manufacturing systems and processes to produce.

What is needed is a chassis and method of manufacture which overcomes the above and other disadvantages of known chassis.

### BRIEF SUMMARY OF THE INVENTION

The vehicle chassis and methods of manufacture of the present inventions have various features and advantages which will be apparent from or are set forth in more detail in the accompanying drawings, which are incorporated in and form a part of this specification, and the following Detailed Description of the Invention, which together serve to explain the principles of the present inventions.

### BRIEF DESCRIPTION OF THE DRAWINGS

FIG. 1 is a perspective view of a vehicle including an exemplary vehicle chassis in accordance with the present inventions, along with exemplary body and subassemblies.

FIG. 2 is a perspective view of the vehicle of FIG. 1 without the body.

FIG. 3 is a side view of the vehicle of FIG. 1 without the body.

FIG. 4 is a top view of the vehicle of FIG. 1 without the body.

FIG. 5A is a perspective view of the vehicle of FIG. 1, without the body.

FIG. 5B is a perspective view of the vehicle chassis of FIG. 1.

FIG. 5C is a cross-sectional view of the vehicle chassis of FIG. 1 taken through the line 5C-5C of FIG. 5B.

FIG. 6A is a side view of the vehicle chassis of FIG. 1.

FIG. 6B is a top view of an exemplary vehicle chassis of FIG. 1.

FIG. 7 is a schematic view of a sheet of material used to form the bumper of the vehicle of FIG. 1.

FIG. 8 is a perspective view of front beams of the chassis of FIG. 1.

FIG. 9 is a schematic view of a sheet of material used to form a front beam of FIG. 8.

FIGS. 10 and 11 are perspective views of a firewall of the chassis of FIG. 1.

FIG. 12 is an enlarged perspective view showing a cross-section of a lower portion of the firewall of FIGS. 10 and 11 taken along line 12-12 of FIG. 5B.

FIG. 13 is a schematic view of a sheet of material used to form the firewall of FIGS. 10 and 11.

FIGS. 14 and 15 are enlarged cross-sectional views of the firewall of FIG. 10 taken along the lines 14-14 and 15-15, respectively, of FIG. 6B.

FIG. 16 is a perspective view of a floor section of the chassis of FIG. 1.

FIGS. 17 and 18 are schematic views of sheets of material used to form the floor section of FIG. 16.

FIG. 19 is an enlarged perspective view of a bulkhead of the chassis of FIG. 1 with enlarged details illustrating an exemplary cellular structural and an exemplary laminate that may be utilized in accordance with the present inventions.

FIG. 20 is a perspective view of a bulkhead of the chassis of FIG. 1.

FIG. 21 is a perspective view of rear beams of the chassis of FIG. 1.

FIG. 22 is a cross-sectional view of a rear end of the chassis of FIG. 1 taken along line 22-22 of FIG. 6B.

FIG. 23 is a schematic view of a sheet of material used to form a rear beam of FIG. 22.

FIGS. 24-27 are perspective views of alternative chassis embodiments.

FIG. 28 is a perspective view of an alternative tub module which may be utilized with the above vehicle chassis in accordance with the present invention.

FIG. 29 is a plan view of a sheet material configured for folding into the tub module of FIG. 28.

FIG. 30 is a perspective view of the sheet material of FIG. 29 superimposed with an outline of the vehicle chassis of FIG. 28.

FIGS. 31a, 31b, 31c, and 31d are respective perspective, plan, front and side views of the vehicle chassis of FIG. 28.

FIG. 32 is fragmentary top plan view of a laminated sheet of material configured for folding into the chassis of FIG. 1, the sheet having one layer with bend-controlling grooves in accordance with the present invention.

FIG. 33A is an enlarged, cross-sectional view taken substantially along the plane of line 2-2 of FIG. 32.

FIG. 33B is a cross-sectional view of a sheet of material similar to that of FIG. 33A illustrating a laminate sheet of material with a bend line.

FIG. 34A is an enlarged, cross-sectional view corresponding to FIG. 33A with the sheet having been bent by 90 degrees from the position shown in FIG. 33A in a direction closing the grooves.

FIG. 34B is an enlarged, cross-sectional view corresponding to FIG. 33A with the sheet having been bent by 90 degrees from the position shown in FIG. 33A in a direction opening the grooves.

FIG. 35A is a front view of a laminate sheet of material similar to that of FIG. 33B in accordance with the present invention.

FIG. 35B is a perspective view of the sheet of FIG. 33B illustrating the sheet after folding into a three-dimensional structure.

FIG. 35C is a perspective view of the sheet of FIG. 35B illustrating use of the bent sheet in an automotive vehicle body.

FIG. 36 is a perspective view of a bent, laminate sheet similar to that of FIG. 35 used in an automotive vehicle body.

FIG. 37 is a perspective view of a laminate sheet similar to that of FIG. 33B illustrating a layer on the inside of the bend line in-situ.

FIG. 38 is an enlarged, cross-sectional view of a laminate sheet similar to that of FIG. 33B, the sheet having bend-controlling structures with stress-reducers.

FIG. 39 is an enlarged, perspective view of laminate sheets similar to that of FIG. 33B, the laminate sheet folded into three-dimensional structures and positioned in juxtaposition to one another.

FIG. 40 is an enlarged, perspective view of sheets of material similar to those of FIGS. 32-34 illustrating a laminate structure on one side of a bend line.

FIG. 41 is a perspective of a laminate sheet similar to that of FIG. 33B illustrating fastening of the sheet of material and layer together with a fastening structure.

FIG. 42 is an enlarged, perspective view of a bent laminate sheet similar to that of FIG. 33B.

### DETAILED DESCRIPTION OF THE INVENTION

Reference will now be made in detail to various exemplary embodiments of the present inventions(s), examples of which are illustrated in the accompanying drawings and described below. While the invention(s) will be described in conjunction with exemplary embodiments, it will be understood that the present description is not intended to limit the invention(s) to those

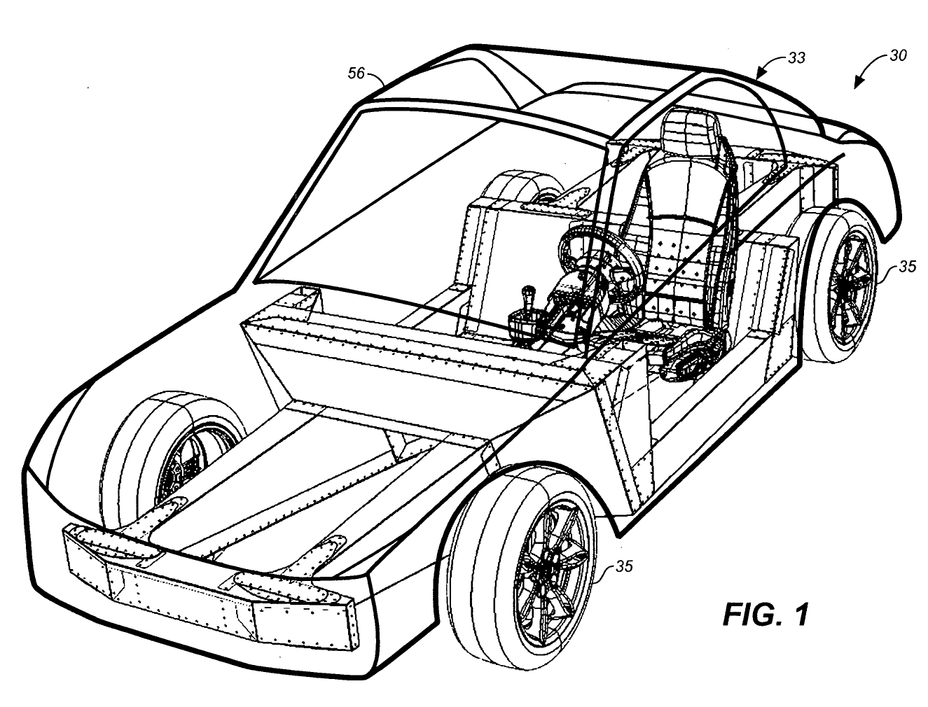

Turning now to the drawings, wherein like components are generally designated by like reference numerals throughout the various figures, attention is directed to FIG. 1 which illustrates an exemplary vehicle, generally designated 30, in accordance with the present inventions. Vehicle 30 includes a chassis, generally designated 32, a body 33, and wheels 35 among other parts. In one embodiment, the chassis supports the body and various assemblies. Such a structure may be referred to generally as a body-on-frame chassis. Body generally refers to the A-surface positioned on top of the chassis such as a body-in-white (BIW).

In some respects sub-assemblies and various components may be considered part of the chassis. In an exemplary embodiment, a suspension assembly 37 is mounted to the chassis (see e.g., FIG. 25) and may be considered part of the chassis or a separate component of the vehicle. Front suspension assemblies may be mounted to chassis 32 along front rails 39. The chassis may include suspension tower mounts 40 fastened to the front rails and configured to provide rigid mounting points for each suspension system. The rigid interface between the suspension components and the chassis ensures that forces applied to wheels 35 are first absorbed by the suspension components rather than the chassis. If tower mounts 40 and chassis 32 lack rigidity, the forces of the suspension assembly may be transmitted to and absorbed by the chassis thereby limiting the effectiveness of the suspension assembly and chassis. Likewise, many other dynamic subassemblies may be connected to and apply loads to the chassis. One will appreciate that the chassis may also support static loads. For example, vehicle 30 may be a pick-up truck with a heavily-loaded bed. The mass of body 33 also applies a load to chassis 32. The body mounts to the chassis along various mounting points as will be discussed in more detail below. For these reasons, chassis 32 and any mounting points to dynamic and static subassemblies should be rigid and strong.

The chassis of the present inventions may include other structures, components, and assemblies. In some embodiments, the body, or portions thereof, may be integrally formed with the chassis. As such, chassis may refer to a chassis frame with suspension, drivetrain, and other components as in “rolling chassis.” Chassis in accordance with the present inventions refers to a variety of chassis architecture including, but not limited to, a unibody construction, body-on-frame, space frame, monocoque, and combinations thereof. Hereinafter, ladder frame and chassis frame will be used interchangeably to refer to the network of beams and component members in the body-on-frame architecture that forms the structure upon which the body is loaded.

Chassis also refers to other design architectures and hybrid designs which bear resemblance to elements of the preceding architecture. As will be described below, the chassis of the present inventions may be configured to carry a load or configured to form or integrate with the overall vehicle or machinery product. For example, the chassis may include an integrated seat component, suspension system components, and the like.

Additionally, chassis may refer to structures, components, and assemblies beyond the normal usage of the term. As one example, chassis may refer to body panels and the like where the body panels play a structural role in supporting the load. Thus, in the case of a unibody construction for a vehicle, certain body panels may be play a significant role in providing torsional stiffness to the vehicle. Chassis thus may refer more broadly to components providing structural rigidity to the machinery and/or in communication with structural backbone of the machinery.

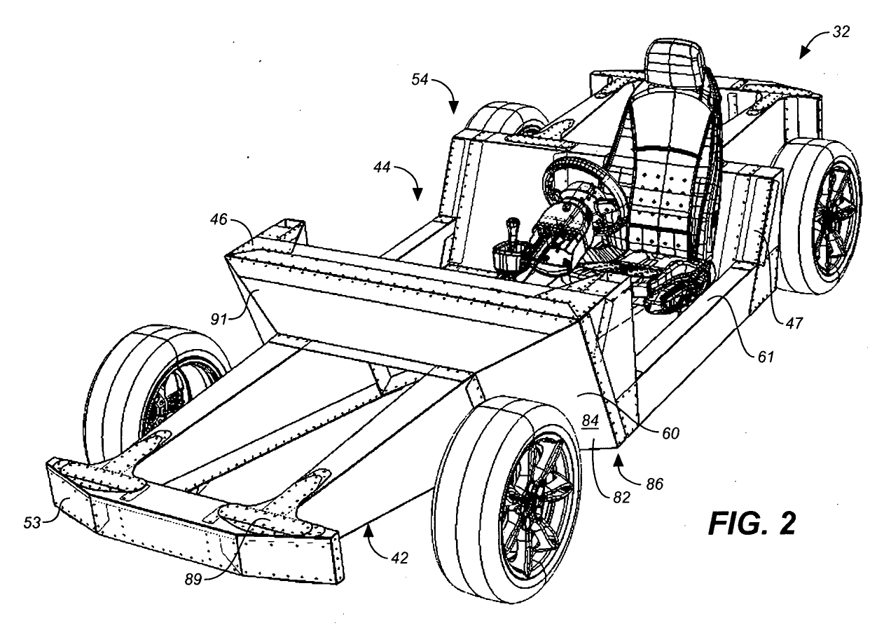

In one embodiment, chassis 32 is an automobile space frame with beams 42 (see, e.g., FIG. 2). In another embodiment, the chassis is a box frame chassis or ladder frame chassis (see, e.g., FIG. 25). As such, the chassis may serve as the backbone of the overall vehicle. In either case, the chassis generally requires rigidity and strength. Twisting, bending, and other forms of deflection in the chassis may cause a related deflection in body 33, subassemblies, and other parts mounted to or on the chassis. Vehicles with chassis having greater rigidity generally exhibit improved performance.

The following description will start by describing an architecture and approach for designing the architecture of a chassis in accordance with the present inventions. Next, exemplary chassis 32 will be described in further detail. Thereafter, the methods and various features of the present inventions will be described in more detail.

Turning to FIG. 2, the design architecture of exemplary chassis 32 allows for a fluid and simple combination of a variety of materials, processes, and joining features. In one embodiment, chassis 32 includes a tub module 44. The tub may be configured as a space frame or hybrid design with nodes at the corners and space for a passenger compartment. A beam structure comprising beams 42 and bumpers 53 extends forward and aft of the tub. The bumpers are located at ends of the beams and extend laterally across the vehicle. The beam structure and tub together comprise the structural foundation of chassis 32. With reference to the figures, it can be seen that chassis 32 further determines or corresponds with the outer boundary of vehicle body 33.

Exemplary tub 44 is preferably formed by joining several sub-components, however, one will appreciate that the tub may be formed from one or more sheet materials. A firewall 46 extends upward and laterally at the front end of the tub, and a pair of front beams 42 extend from the front of the firewall. The firewall acts, in part, similar to a tubular space frame with each side of the firewall modeled similar to tube structures. An A-pillar further extends upward from a point, generally referred to below as a node, at the upper portion of the firewall. The A-pillar may be formed as part of the chassis, body, or both. Likewise, rear bulkhead 47 acts similar to a bar linkage at the rear portion of the tub. Further, C-pillars extend upward from the bulkhead. One will appreciate that the chassis may be configured such that B-pillars extend upward from the bulkhead or other portions of the chassis. In an exemplary embodiment, firewall 46 includes pillar slots 49 at each side to receive and position A-pillars.

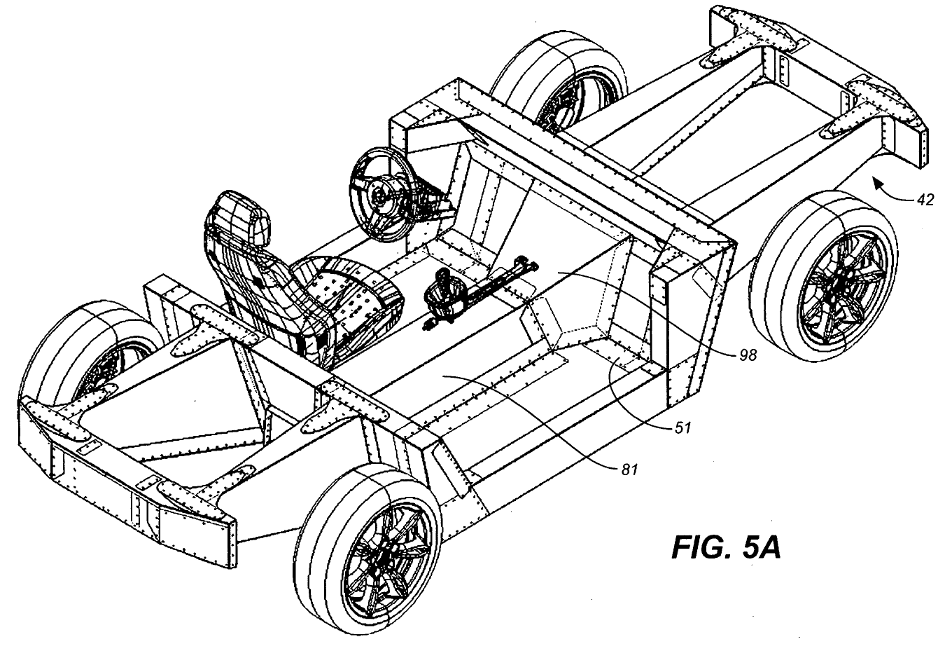

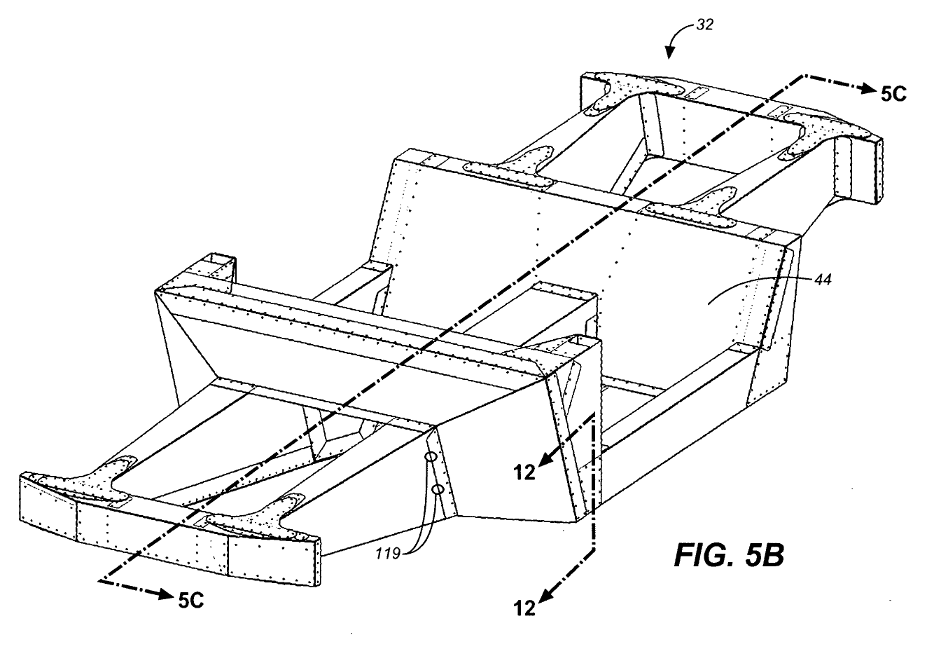

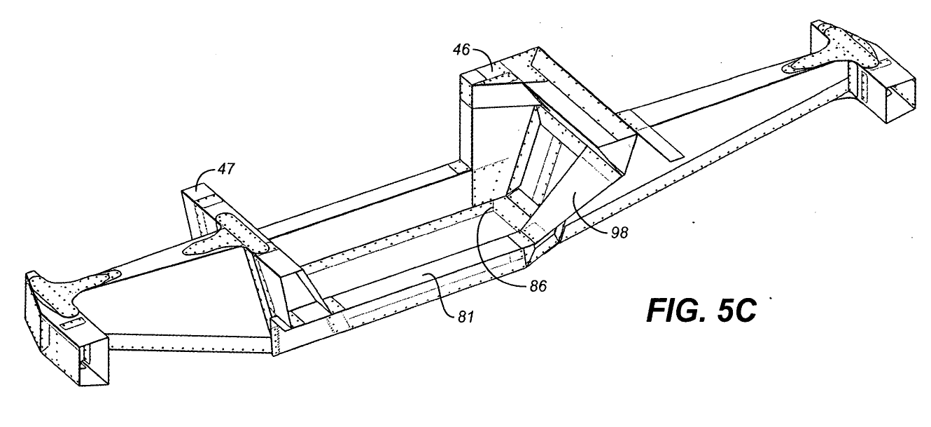

In an exemplary embodiment, both bulkhead 47 and firewall 46 of tub 44 are formed from sheets of material prepared for bending along a plurality of bend lines and subsequently folded into three-dimensional structures. In contrast, tub floor 58 is generally a planar pan sheet. However, each of these components may be formed from a sheet, frame members, or other suitable methods and manufacturing processes. The floor and firewall form a common line of engagement 51 where they meet and intersect (see, e.g., FIG. 5A). Thus, forces in the firewall and bulkhead may be transmitted across this line of engagement to the floor.

For the purposes of the present invention, the term “node” refers to geometrical points in the chassis and/or along the load path. The node may be formed in the sheet of material, for example, the sheet forming the floor or the firewall. Alternatively, the node may be bonded to another structure or left free depending on the application. Bonding may be done by welding, adhesive bonding, mechanical fasteners and the like.

Exemplary chassis 32 makes use of cold and hot curing adhesives and rivet bonding to join component members. A separate component may also serve to connect the members such as a die cast component interconnecting edges of the firewall and floor. Further detail regarding the joining processes of the present inventions are provided below.

The front and rear portions of exemplary chassis of FIG. 2 includes longitudinally extending beams 42 and bumpers 53 extending laterally across the beams. Thus, the front and rear of an exemplary chassis are similar to tubular ladder frames, while tub module 44 is similar to a space frame. In this manner, the chassis of the present inventions may be categorized as a hybrid chassis design.

Similar to firewall 46, other component members of chassis 32 may be formed from a sheet of material or by techniques such as roll forming, die casting, extrusion, pressing, hybrid techniques, laminating, and more. Each of the components members may also be joined thereafter using various joining techniques.

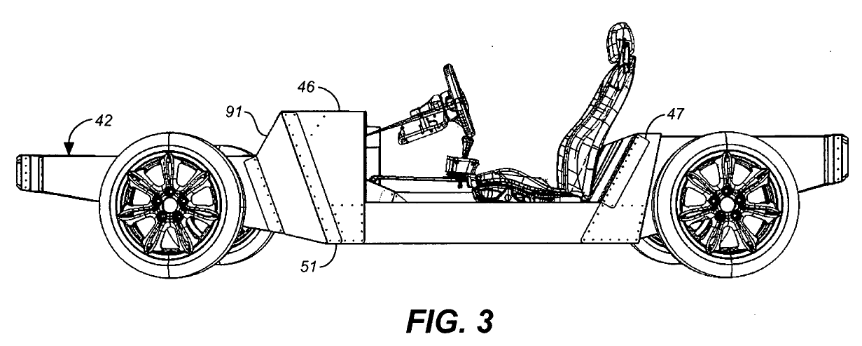

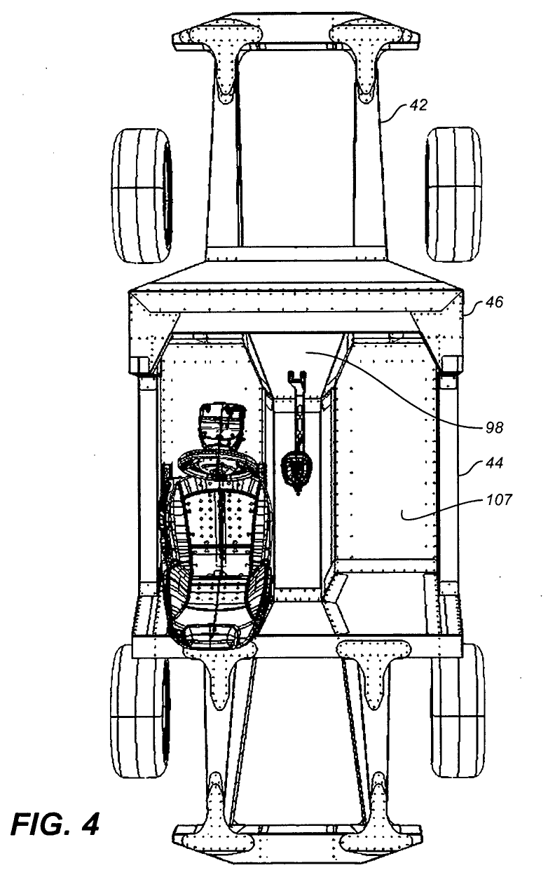

With particular reference to FIGS. 1-6, several approaches may be taken to the design of chassis 32 over conventional techniques. One approach calls for substituting prior chassis manufacturing techniques with a folding technology. In one embodiment, one or more of the three-dimensional forms of the chassis are formed from a two-dimensional sheet of material folded along a plurality of bend lines.

The sheet folding approach of the present inventions allow for consolidation of parts. A conventional chassis design may call for a chassis tub having a frame with box beams, which chassis would often be formed by welding panel sides together into the box beams. Alternatively, the box beams may be formed by extrusion or by another process. The beams of the box frame are then welded together into the frame. In contrast, chassis frame 54 is formed from a reduced number of sheets, and preferably from one or more sheets of material. In this manner the process of manufacturing the chassis frame is simplified and improved. In contrast to conventional welding or extrusion, the described process allows for faster and simplified manufacturing. The method of the present inventions allows for precision folding such that box frames and the like may be accurately manufactured with reduced specification tolerances. The method of the present inventions may also provide other benefits such as greater design flexibility and increased rigidity as will be described.

Another approach to chassis design in accordance with the present inventions calls for increasing utilization of the processes and methods described to vastly increase the diversity of chassis designs available. The chassis architecture may be derived with little regard for the limitations of conventional techniques. The processes and methods that will be described below allow for greater manufacturing flexibility among other benefits which allows for designs not capable with conventional techniques. Thus, one may design a chassis based on any number of design guidelines in accordance with the present inventions. In contrast to conventional chassis architecture informed by long-held beliefs that a chassis must include specific design elements and must derive from a minimum number of materials and processes, chassis of the present inventions freely combine processes and materials. For example, chassis 32 combines beams with boxes and sheets. The structures and methods of the present inventions also allow for use of carbon fiber, foam, aluminum, steel, and other materials all dispersed within a chassis.

In various embodiments, the chassis design is based on hard or defined geometrical points or features dictated by the body design or performance parameters desired rather than structural or manufacturing limitations. “Geometrical points” and “geometrical features” refers to the design of the chassis as a structural element. In accordance with the description herein, “geometrical points” refers to loading points or load paths in the context of designing the chassis for loading. As described herein, the chassis may be designed in a manner similar to a truss whereby “geometric points” and “nodes” of the chassis corresponds to pins in a truss. The bend lines and edges of the chassis correspond to truss chords. In the context of designing the chassis for supporting a particular body design, and in particular a chassis integrated with a body, “geometric features” refers to aesthetic geometric features. For example, a bend line of the chassis along a side beam may correspond to a lower door sill in the exterior body, an edge of the chassis may correspond to a fender flare, and so forth. By a bend line “defining geometrical features,” it is meant that the bend line, an intersection of the bend line with another feature line, or an end of the bend line defines a geometrical feature.

In various embodiments, the chassis has features reflective of the desired aesthetic geometrical features (i.e. “A” surfaces) or the load points of the body on the chassis rather than manufacturing-dictated features. As an example, the chassis may include a bend line corresponding to an inflection point in the body rather than providing a specific component to create such an inflection. The design of chassis 32 may also be informed by the design and dimensions of the overall vehicle or the body. The described technology reduces or eliminates many conventional chassis design limitations. Thus, the body and other characteristics of the vehicle are not as limited by the standard chassis structure.

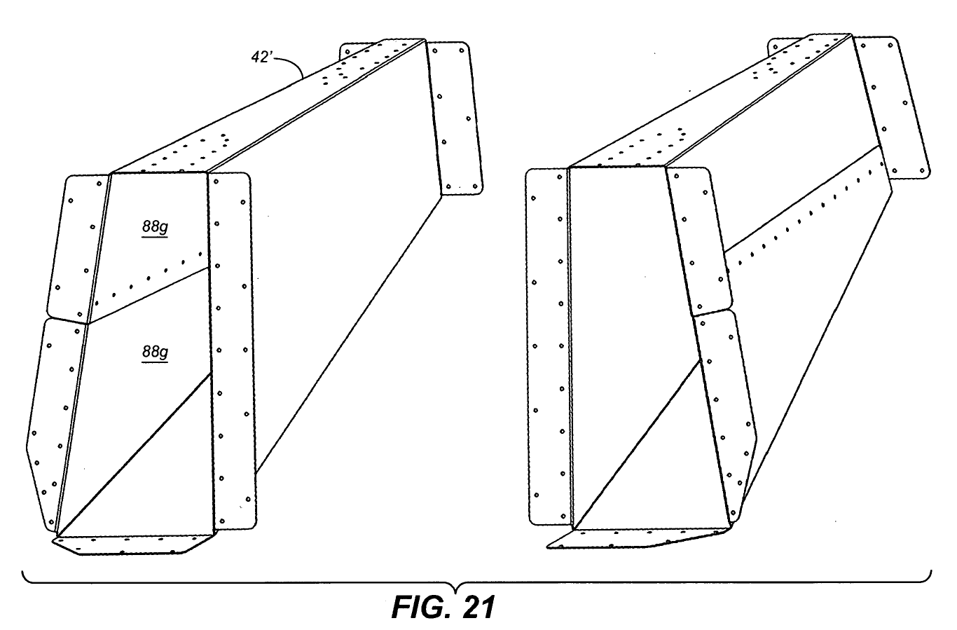

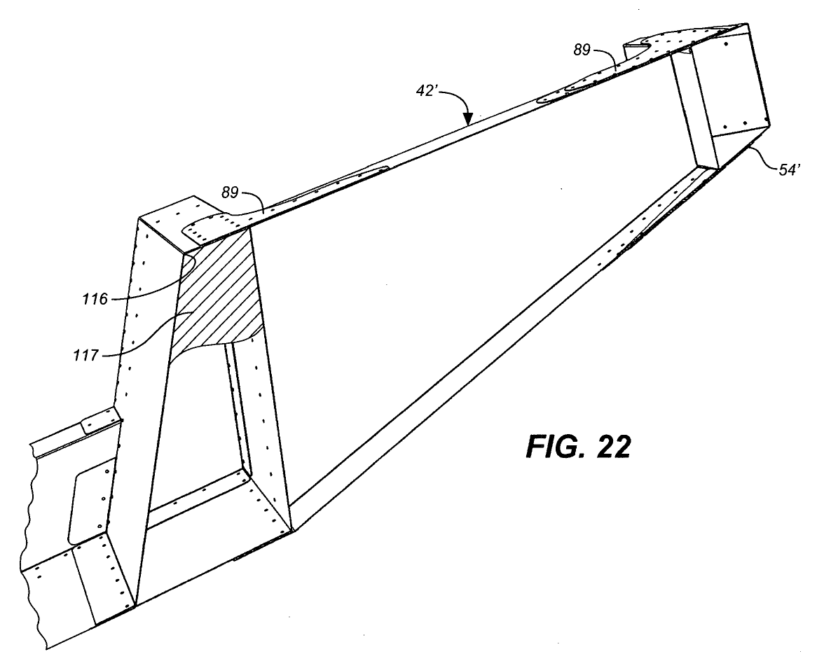

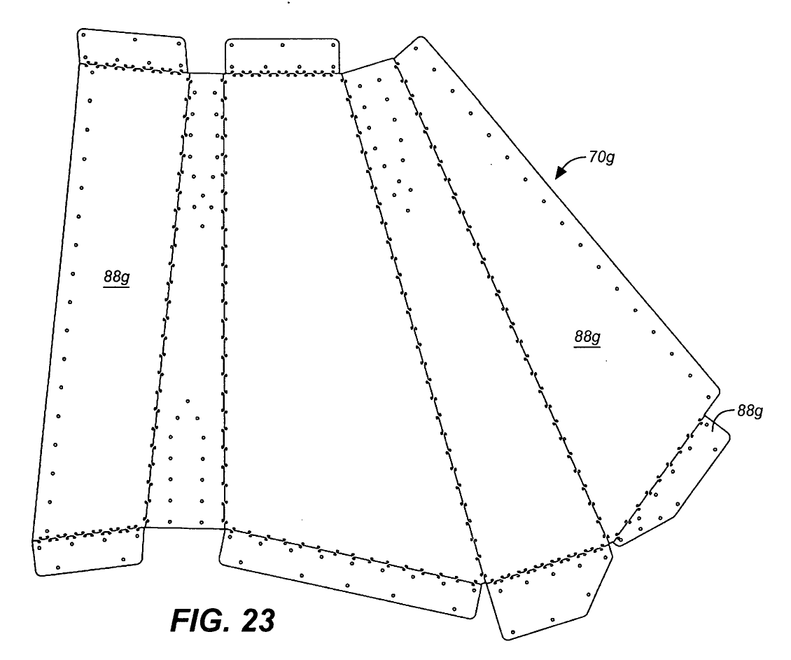

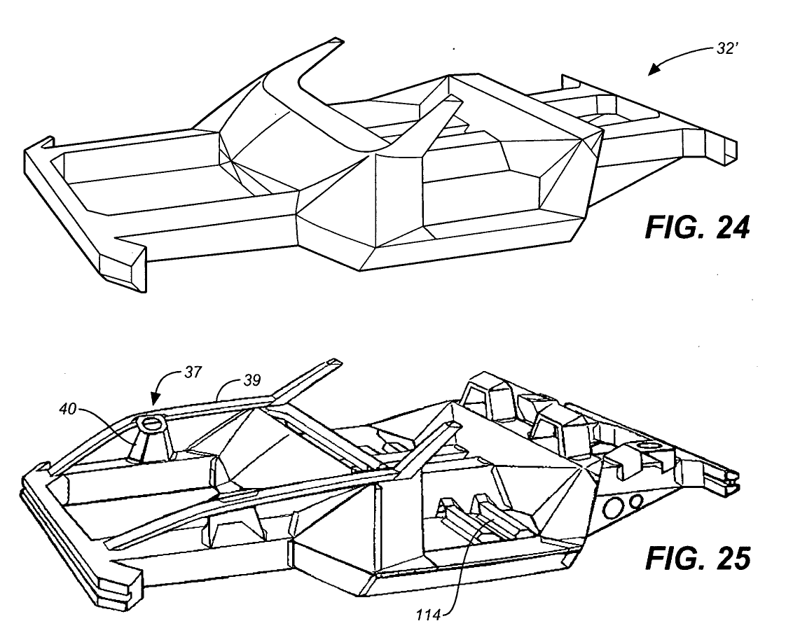

The design of exemplary chassis 32 begins by laying out the architecture in an initial sketch form (best illustrated in FIG. 24). Although the chassis may be viewed as a cohesive unit, the chassis may be formed through a variety of manufacturing processes using a variety of materials. In one embodiment, roof rails 56 are extruded metal, tub 44 is a folded sheet, and various other components are die-cast metal. In one embodiment, the floor and various other components are folded sheets of metal filled with foam and/or layered with a structural material such as carbon fiber. Suitable materials for the sheets of material in accordance with the chassis of the present invention include, but are not limited to, aluminum, steel, and other metals; plastics; composites; and the like. The chassis may be formed of a single material or mixed materials. Further, each component part may be a uniform material or mixed material. The sheets and materials used to form the chassis may also include laminate structures as will be described below. The diverse materials forming the component parts may be joined to form the resulting chassis in accordance with the present inventions as will be described in more detail below.

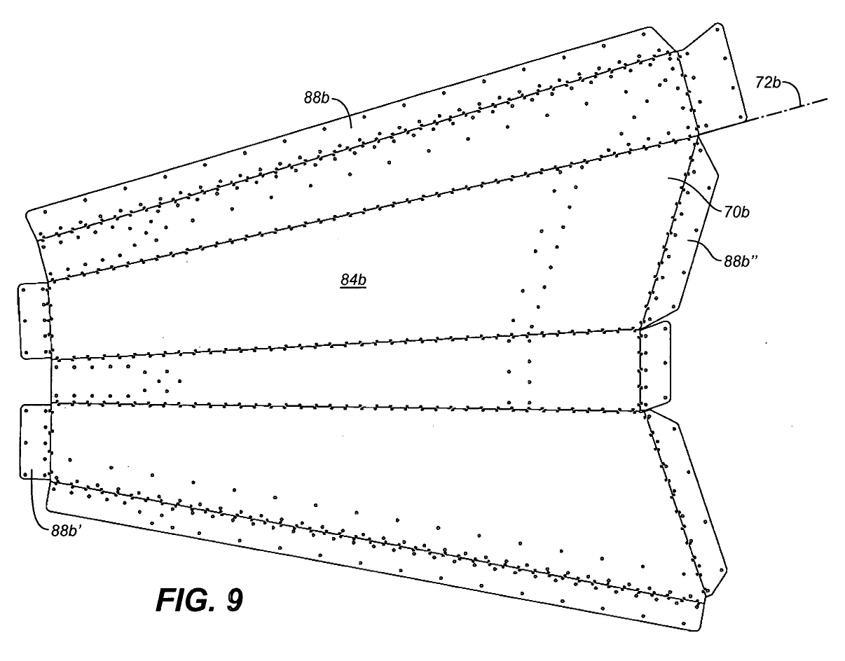

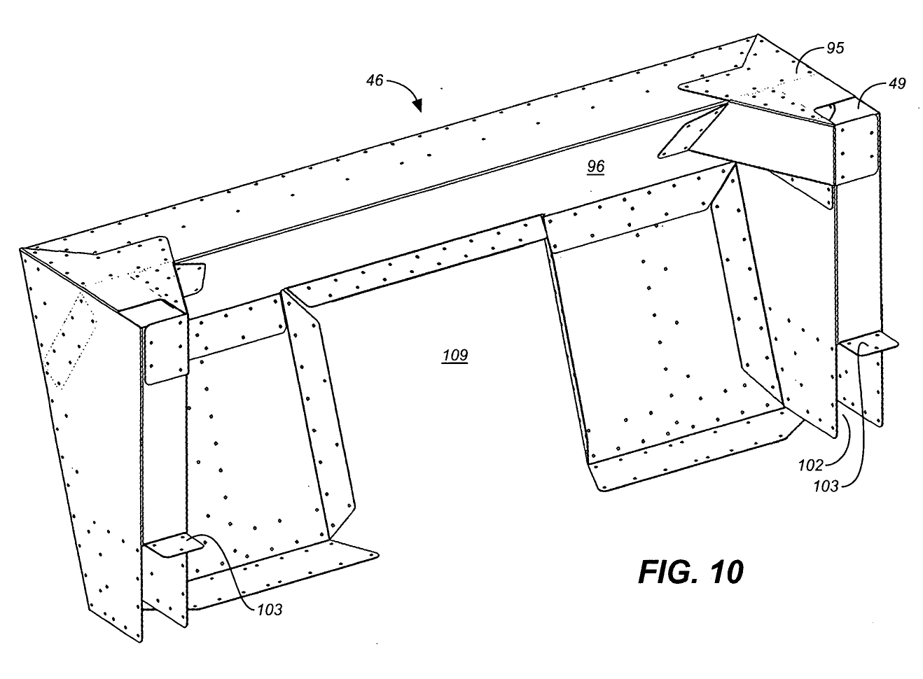

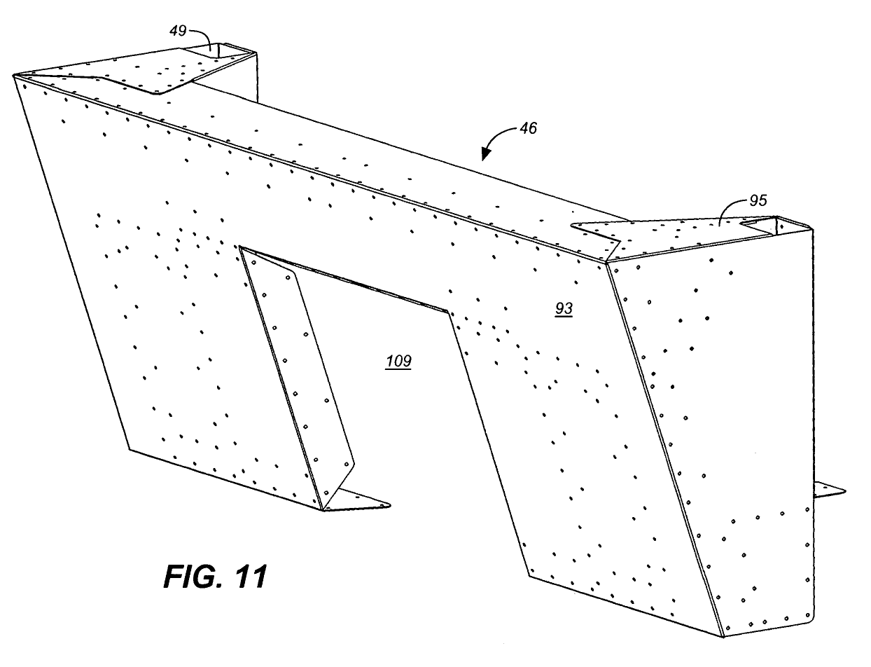

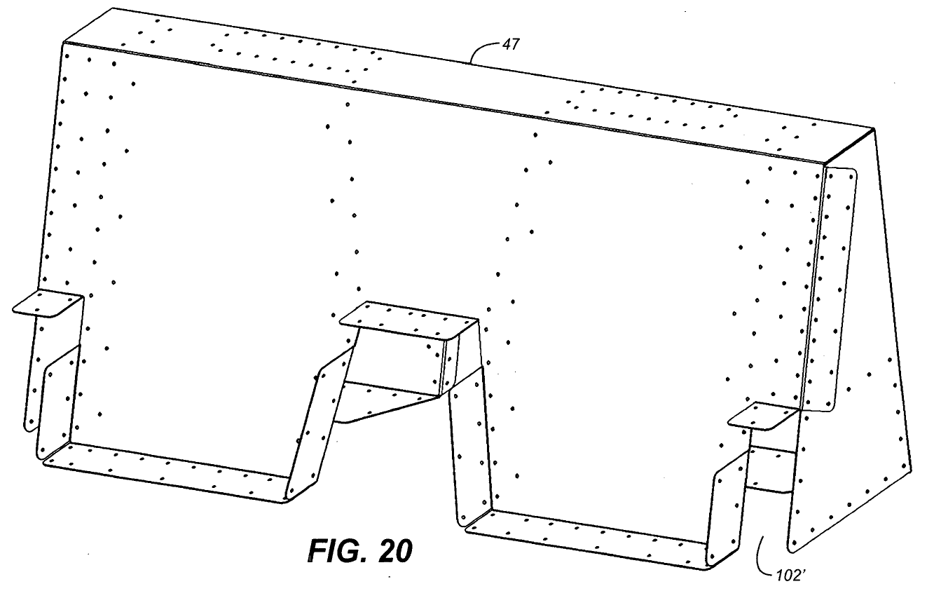

With reference to FIGS. 2-23, chassis 32 may include components and assemblies formed with tubes, panels, three-dimensional forms, sheets, and the like. In one embodiment, tub 44 includes a floor 58, shroud 60, firewall 46, and rocker beam 61. The rocker beam may be integral with beams 42 or separately-formed. In one embodiment, a similar design is replicated in the rear of the tub. The tub includes a rear bulkhead 63 having a riser portion 65. The vehicle may include pillars 67, which are generally referred to in relation to their respective positions such as A-pillar, B-pillar, C-pillar, and so forth. In one embodiment, a pair of A-pillars 68 extend from front beams 42. The A-pillars may also be attached to or integrally formed with other components such as the firewall or shroud. Likewise, rear pillars may be attached to or formed with the bulkhead or other members.

In one embodiment, tub 44 includes sub-components with varying structural configurations. For example, roof rails 56 are generally tubular or box-beam shaped but bulkhead 47 is generally a polygonal, three-dimensional structure.

In one embodiment, tub 44 is formed from several two-dimensional sheets of material 70. The sheets include a plurality of bend lines 72. The bend lines are defined by positioning structures 74. In an exemplary chassis 32, several components can or may be fabricated using folding technology.

The folding technology of the present inventions generally involves preparing a sheet of material with positioning structures that define a bend line. The positioning structures may be strap-defining structures, slits, displacements, grooves, or other structures that promote and facilitate bending. In many aspects, the sheets of material and methods of preparing such sheets are similar to those disclosed by U.S. Pat. No. 6,481,259, U.S. Pat. No. 6,877,349, U.S. Pat. No. 7,152,449, U.S. Pat. No. 7,152,450, U.S. patent application Ser. No. 10/821,818 (Pub. No. 2005/0005670), U.S. Pat. No. 7,032,426, U.S. Pat. No. 7,263,869, U.S. Pat. No. 7,222,511, U.S. patent application Ser. No. 11/357,934 (Pub. No. 2006/0261139), U.S. patent application Ser. No. 10/952,357 (Pub. No. 2005/0064138), U.S. patent application Ser. No. 11/384,216 (Pub. No. 2006/0207212), U.S. patent application Ser. No. 11/080,288 (Pub. No. 2005/0257589), U.S. patent application Ser. No. 11/374,828 (Pub. No. 2006/0213245), U.S. patent application Ser. No. 11/180,398 (Pub. No. 2006/0021413), U.S. patent application Ser. No. 11/290,968 (Pub. No. 2006/0075798), U.S. patent application Ser. No. 11/411,440 (Pub. No. 2007/0113614), U.S. Provisional Patent Application No. 60/665,577, U.S. patent application Ser. No. 11/386,463 (Pub. No. 2006/0277965), and U.S. Provisional Patent Application No. 60/854,846, which are each incorporated herein by reference in their entireties (“related applications”). In these applications several techniques and manufacturing processes for forming positioning structures that will precisely control bending of sheet material are disclosed. The emphasis in these related applications is in connection with the use of slits, grooves, and displacements which provide control bending.

In one embodiment, positioning structures 74 are strap-defining structures that define a bending strap 75 having a longitudinal strap axis 77 oriented and positioned to extend across the bend line. Additionally, the positioning structures may be configured in accordance with particular manufacturing or performance specifications. In one embodiment, the positioning structures are slits and a plurality of the structures include a central portion extending along the bend line and stress-reducing structures at end portions thereof. In one embodiment, the positioning structures have end portions that curve away from the bend line such that adjacent pairs of bend-facilitating structures define bending straps therebetween. The bending straps may further extend obliquely across the bend line.

Positioning structures 74 may be adjusted or modified in accordance with the present inventions. In an exemplary embodiment, the positioning structures on beam 42 are slits with central portions extending along the bend lines and end portions diverging away from the bend line. At least one of the positioning structures further includes ends that curl and return back towards each other thereby advantageously directing stress concentrations to neutral zones in the material during bending. As described in the '398 application above, which is incorporated by reference, such a structure yields increased fatigue resistance. The position and dimensions of the positioning structures on an exemplary beam are further selected to suit the particular application. In an exemplary embodiment, the positioning structures are strap-defining structures similar to those disclosed in the related applications. The positioning structures along the length of beam 42, therefore, define straps of varying widths and dimensions. Along the middle, the straps are narrower for decreased bending resistance. Closer to firewall 46, the straps are wider for increased bend line rigidity.

In one embodiment, the strap-defining structures may be configured to create a crumple zone. In an exemplary embodiment the strap width is thin in the front and generally increases moving in a direction towards the rear along front beams 42. Alternatively, the frequency of the straps along the length of the structure may increase towards the rear. Thus, in an impact, the front of the front beams will collapse and absorb impact energy. The front beams and other chassis components may be configured in similar manner for impact and other conditions outside of normal operating conditions. Many other modifications and adjustments may be made to the chassis depending on such factors as loading arrangements, bending and manufacturing concerns, and performance specifications. Similarly, such modifications may be made to any other component in the chassis as will be understood from the description herein.

In an exemplary embodiment, positioning structures 74 form at least one bend line within a sheet material and extend along an edge of chassis 32 once the sheet material has been bent. In an exemplary embodiment, rocker beam 61 is formed in part from a two-dimensional sheet folded along the bend lines. Thereafter, the three-dimensional structure is connected to other components to form tub 44 and chassis 32.

With reference to FIG. 2, several of the bend lines of the rocker beam form edges of the chassis geometry. Exemplary rocker beam 61 is a box-section whereby one of the lower bend lines defines a door sill of the vehicle. Accordingly, the bend lines of any of the folded chassis components may define the overall geometry or a geometrical feature of the chassis. Such bend lines and edges may also form a skeletal structure of the chassis.

Turning to FIG. 5B, exemplary chassis 32 includes one or more sheets of material. An exemplary chassis is formed by joining many component pieces formed of sheets of materials. The joining of distinct components creates at a junction point or line. Similar to bend lines 72, this junction may also define a geometrical feature of the chassis. In one embodiment, the rear of bulkhead 47 connects to rear beams 42. As shown in FIG. 1, the junction of these components in an exemplary embodiment corresponds to the C-pillar and bottom of the rear window of the vehicle. In one embodiment, the contours of rocker beam 61 define geometrical features of the vehicle sides and door sills.

### Orientation of Chassis Components

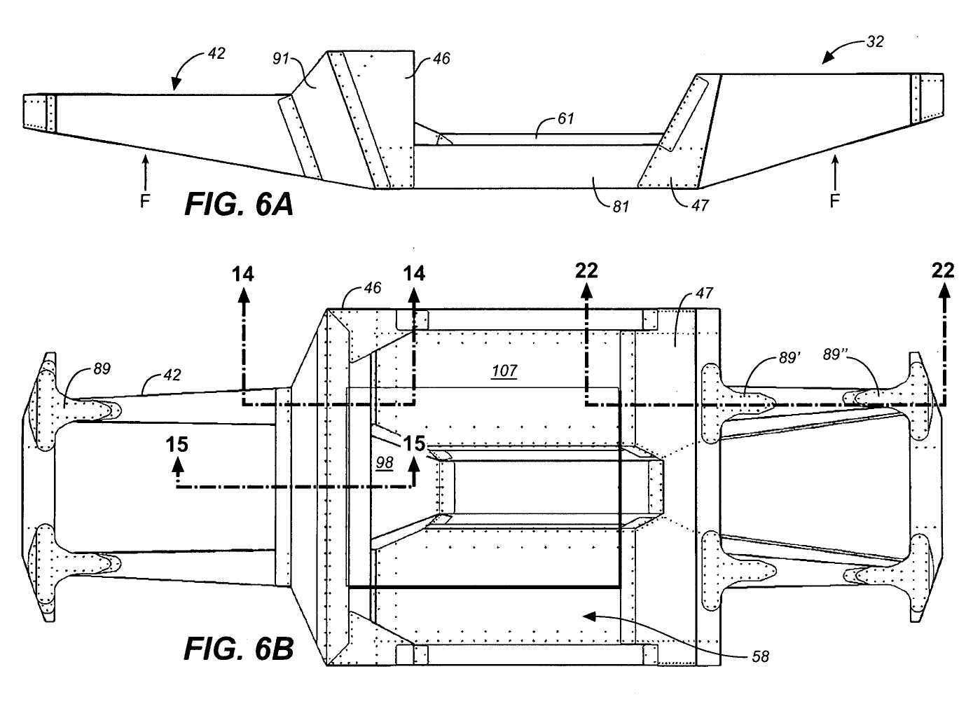

Geometrical feature may correspond to features other than body aesthetics including loading features and chassis design features. Referring to the figures, the exemplary chassis in FIG. 5B is more generic in contrast to the exemplary chassis in FIG. 25 which is specifically configured with suspension load points. In one embodiment, a bend line of the tub defines a load path of the chassis. As already noted, chassis 32 may be configured to support loads at several locations. One of the primary load points is a suspension mounting point where loads from the wheels are transferred to beams 42 of chassis. Therefore, the beams in concert act like cantilevers. Loads from the wheels generally create a “sagging” load (or the reverse as the vehicle bounces) on the chassis (best seen in FIG. 6A). Sagging refers to the simplified case of upward forces, denoted as F, at the front and rear of the chassis and a downward force in the middle of the chassis. In this simplified case, the chassis is subjected to tension along a bottom path and compression along a top path. In an exemplary chassis a bend line along the bottom of tub 44 defines such a load path along the bottom of the chassis.

Chassis 32 may also be considered a network of nodes and connecting lines. For example, points where lines or edges of the chassis change directions distinctly may be considered nodes. The faces or sides of beam 42 and other structures form the connecting lines or chords. These points may also define physical features of the chassis or vehicle such as inflection points in the vehicle body. These points may define geometrical features such as mounting points or physical limitations of the chassis.

Such points at which connecting lines change direction also by their nature define features of the load paths. For example, an offset, longitudinal load along an edge of the chassis will impart related linear loads in the x-y-z directions and a moment. The points at which the load path is transformed or changes direction may also be referred to as a node. These points are generally defined by changes in the architecture of the chassis. For example, a flat structure may intersect a perpendicular structure and the load will be said to travel around the corner.

In various embodiments, the chassis architecture of the present inventions takes advantage of the above principles by maintaining substantially linear paths between loading points. In one embodiment, any transition point between linear paths is gradual and abrupt transitions or sharp corners are minimized. The transitions promote desirable distribution and control of loads in the structure. In an exemplary embodiment, transmission tub 44 includes a tunnel intermediate panel 79 between tunnel 81 and firewall 46. Among other things, the tunnel panel provides a smooth longitudinal transition between the path along the tunnel walls and the panels or faces of the firewall.

With reference to FIG. 2, a flare 82 is provided to smooth the lateral transition between rocker beams 61 and beams 42. Because beams 42 are laterally inward of the rocker beams, the flare smooths the transition between the two members. In contrast, without the flare, the junction between rocker beam 61 and beam 42 would be a sharp corner. In such a case, a portion of the force traveling through the beam would create a high moment at the junction with rocker beam. In essence, the flare smooths or eliminates the junction point such that the load is distributed from beam 42 to the rocker beam while reducing moment and lateral forces. In an exemplary embodiment, flare 82 is integrally formed with shroud 60.

In one embodiment, the load path emanating from each wheel 35 is substantially linear such that the loads from the front and rear wheels are directed towards each other. This means that the load applied to the chassis from wheel loading creates a sagging load. The compressive forces from the sagging load are thus directed in-line towards each other. The top plane of the chassis would thus be substantially in compression with minimal moment forces created.

In a conventional chassis, the load path veers and turns at each point where tubes or planes meet. Such points may be weld points, die cast junction components, bosses, or any other junction configuration. In contrast, the chassis configuration of the present inventions makes advantageous use of the characteristics of standard materials by subjecting the materials to compressive forces and minimizing torsional or bending forces on the material. This configuration makes efficient use of the properties of the materials employed.

As described above, chassis 32 may be formed in part from sheets of material similar to sheet 70. Such sheets may be folded into various component products including, but not limited to, tube-like structures similar to tubes found in traditional body-on-frame chassis, larger three-dimensional structures similar to a firewall in a space frame, or body structures and panels in the case of unibody or body integral chassis.

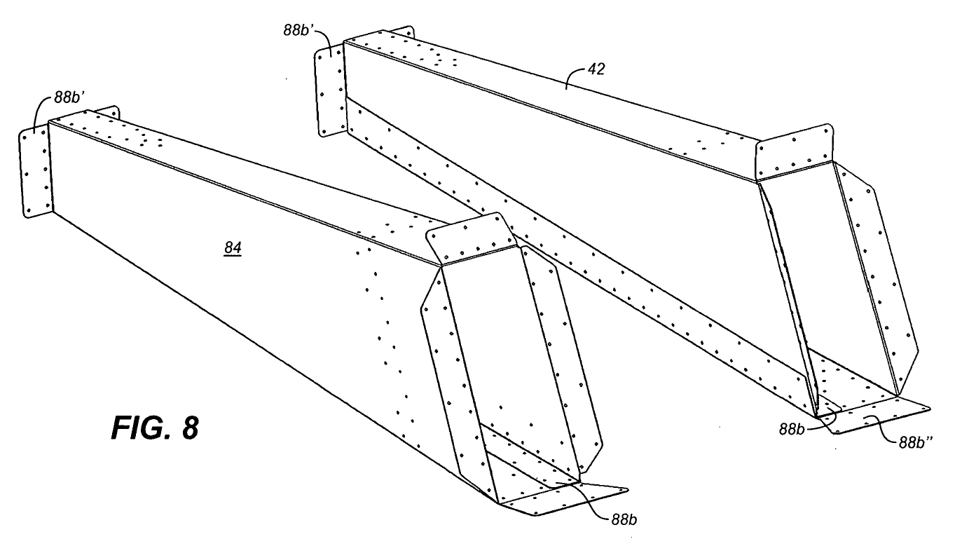

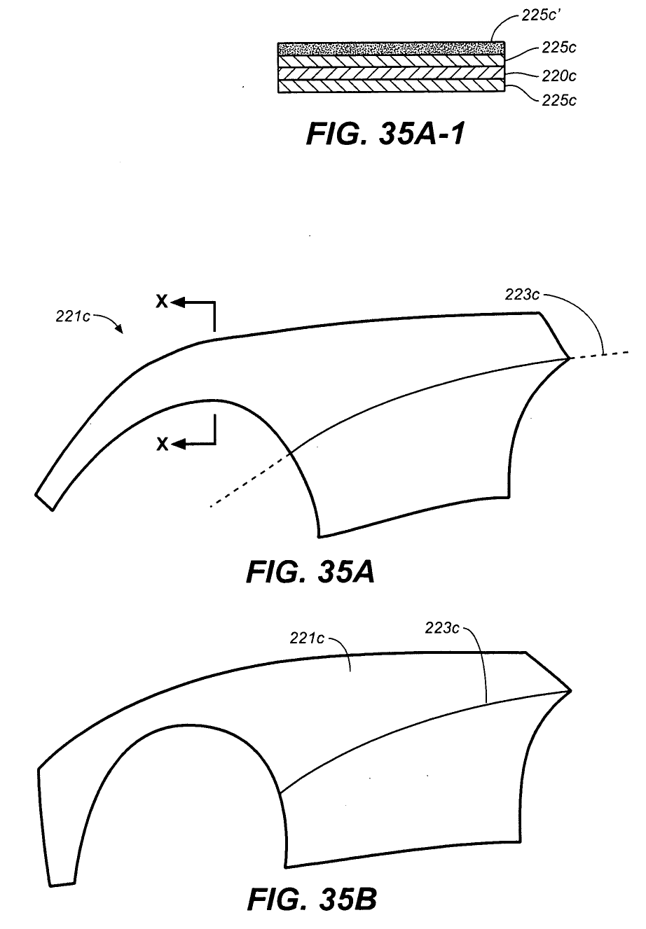

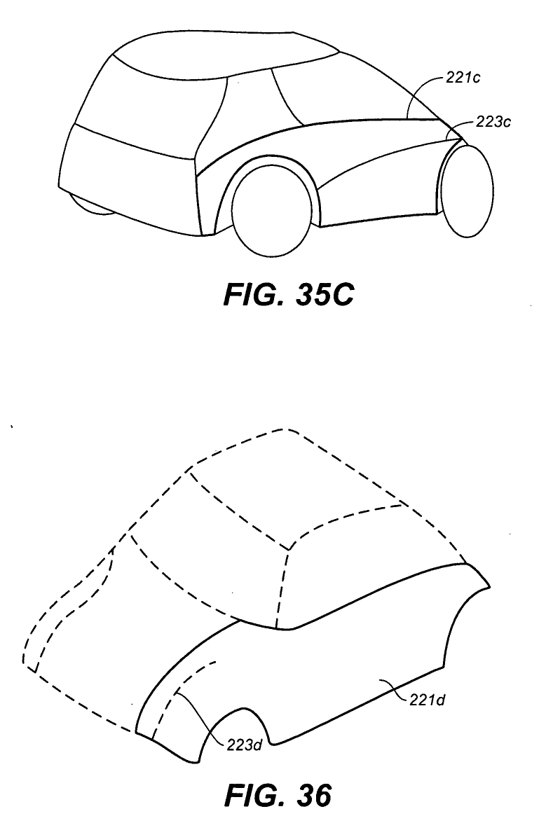

In one embodiment, at least one chassis member is formed from a sheet of material having a plurality of bend lines and at least two of the bend lines are configured and positioned such that upon bending the at least two bend lines define a hard geometrical point in the chassis architecture. The bend line may define a hard line or soft inflection in the chassis architecture. A hard line refers to a something like a rigid edge (e.g. FIG. 8). A soft inflection refers to a transition or edge of a curvilinear face (e.g. FIG. 35). For example, the chassis may include a cosmetic cover on the interior of the passenger compartment having multiple curvilinear panels segmented by a bend line.

Chassis 32 may also have a hybrid design incorporating features of a truss and space frame or unibody. In one embodiment, the chassis is modeled similar to a truss and the design of the chassis is informed by the functional features of the truss model. Chassis 32 of FIG. 2 is essentially a hybrid space frame combined with a monocoque. Many of the components parts of the space frame have a polygonal shape. The outer panels of each chassis member can be seen as demarcating a truss-like structure (best shown in two dimensions in FIG. 6a) or a geodesic skeletal structure. The particular combination of three-dimensional polyhedron structures in the exemplary chassis provides significantly increased strength. Each of the sections of the chassis may be modified in accordance with this understanding depending on the application. In the exemplary chassis, the tunnel is configured as a virtual polyhedron. The instrumental panel, which has a triangular cross-section, extends fully across the vehicle to provide rigidity in three dimensions. The chassis and each individual member may modified similarly regardless of whether the member is a primary member or whole structure like the instrument panel.

The loading of such components may be modeled with simplified modeling guidelines. Although not intended to be an accurate illustration of actual loading, such guidelines may facilitate the design of chassis architecture. By simplifying the load paths through the chassis, the chassis may be modeled similar to a plane truss or space truss where the edges of the panel of the chassis space frame are treated like truss chords.

The relevant components are first identified. Anything that can take a load will take a load. For example, soft elastic material may be used for sound-deadening or other purposes throughout the chassis. Such materials will not absorb or support a significant load. On the contrary, components likes bulkhead 47 will take a load and thus may be configured specifically to support and receive loads on chassis 32.

It has been found that loads applied to such load-bearing components, in general, travel primarily along edges of the components to corners. In a three-dimensional structure, the load will tend to move to the edges rather than traveling through the panels. The load path may further be modeled by treating the load as moving along the longest load path.

Chassis 32 involves a plurality of angular structures that form corners in the structure. Such structures meet at as junctions. Further, individual components and assemblies may include junctions, which may also be referred to as apexes. In the context of the chassis geometry and load analysis, such junctions also define nodes as described above. A sharp angle formed between members meeting at a junction point may lead to failure. Sharp angles may also lead to a high moment at the junction. Therefore, chassis 32 may be configured to reduce the occurrence of junctions and apexes with sharp angles to advantageously manipulate the load path through the chassis.

With the above principles, exemplary chassis 32 may be understood as being configured as a cantilever beam with a truss-like structure. Viewed from the side of the vehicle (best seen in FIG. 6a), the front and rear axles apply a load F at each end much like a cantilever beam. In an exemplary embodiment, panels 84 forming tub 44 therefore can be modeled as a plurality of beams for the sake of simplification. With respect to tub, some, if not all, of floor 58, bulkhead 47, shroud 60, flare 82, firewall 46, risers 65, and tunnel 81 have panel sides that form a truss-like structure.

In one embodiment, the firewall and/or bulkhead are configured to support a moment load along the top or bottom load path of chassis 32. In particular, the firewall or bulkhead includes a panel connected to the load path to counter the “sagging” load by translating moment into a tensile or compressive load in the direction of the panel.

In one embodiment, the panel edges are treated as chords of a truss. Thus, the panels are angled with respect to each other such that the sum, in the aggregate, of all horizontal, vertical, lateral, and moment forces are minimized, and more preferably substantially equal zero. Further, substantially vertical members may be selected to withstand shear forces in the truss web. The analysis of the chassis in this instance may proceed by analysis of the chassis load paths along nodes defined by the junction or intersection of planes, beams, or other members of the chassis. In this case, the nodes may be treated as hinged members. Alternatively, the corners of the structures or connection between separate members may be configured to support a load or moment.

One will appreciate that the panels may be provided with apertures or openings 85 to reduce weight of the panels while still maintaining the truss-like structural integrity of the structure (see, e.g., FIG. 2).

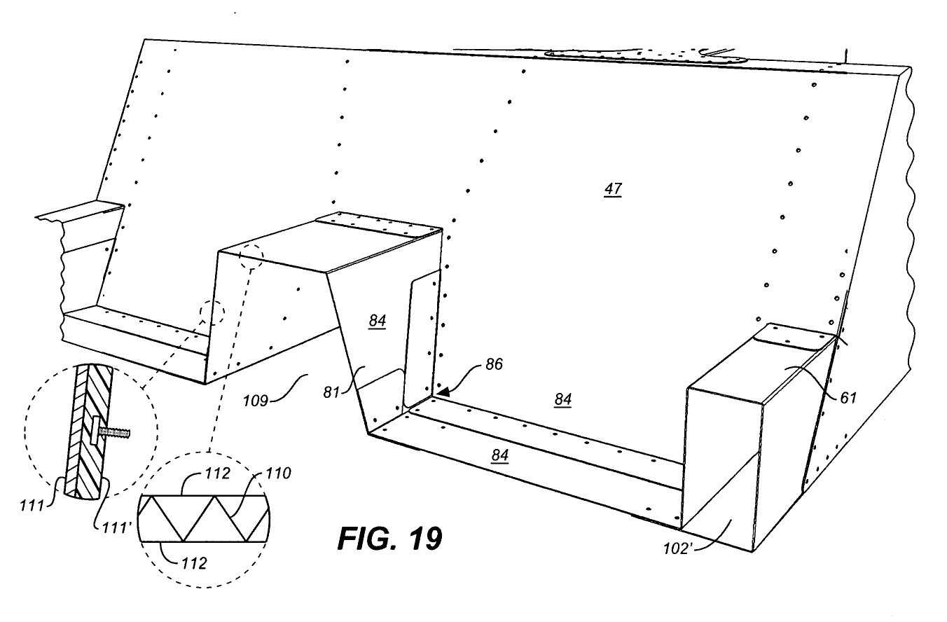

With reference to FIGS. 2 and 19, the junction between chassis members may form a quilted apex 86 to further control loads moving across nodes. Quilted apex refers to a junction or corner with a transition zone. The junction may also be defined by an apex between at least three adjacent panels 84. In an exemplary embodiment, a corner formed by at least three intersecting bend lines includes a quilt panel in place of a sharp corner. Whereas three intersecting bend lines in a box-like structure would normally form a substantially 90-degree corner, the quilt panel forms a transition between adjacent sides without a significant corner. The quilted panel configuration may also be formed simply using the sheet preparation and folding features described above in contrast to a fully rounded corner. Quilted corner configurations may be employed throughout the chassis depending on the application.

Similar to transitions employed by quilted apexes 86, flare 82, and the like, the larger chassis members may also include transition zones. With particular reference to FIG. 19, rear bulkhead 47 may include a plurality of panels which transition to the flat bottom as opposed to an upright panel connected directly to a horizontal floor panel. Among other things, such transitions allow for control and distribution of load paths as well as decreasing the moment created between adjacent panels.

### Chassis Example

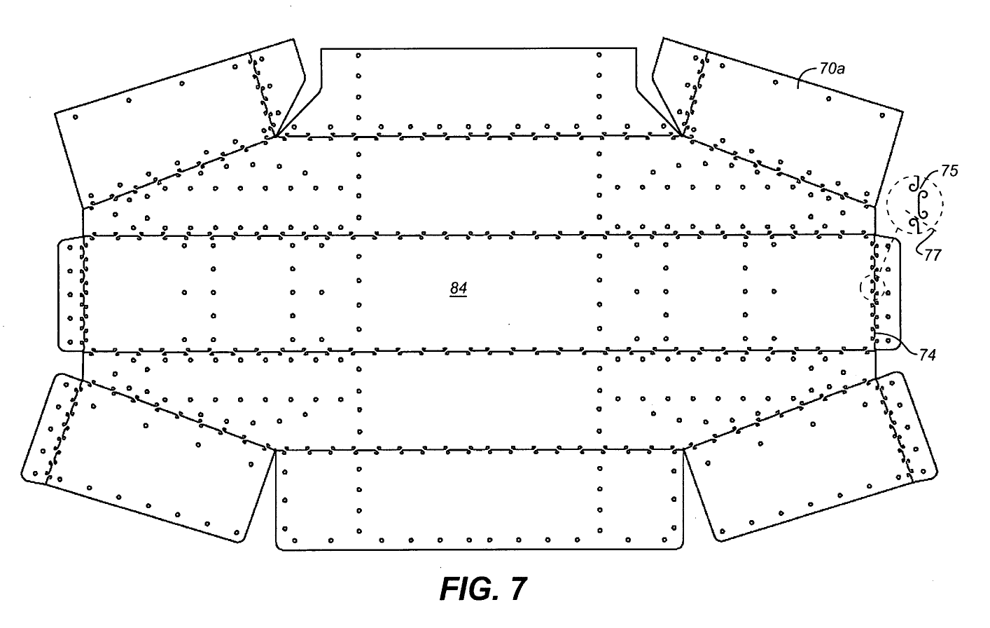

The respective components of exemplary chassis 32 may now be described in greater detail. An exemplary chassis is formed by joining three-dimensional structures primarily formed by bending sheets of material. At the outer limits, front and rear bumpers 53 extend laterally at ends of front and rear beams 42. The bumpers are formed from a single sheet of material 70a (shown in FIG. 7). The sheet of material includes a plurality of bend lines defining panels of the sheet. In the alternative, the bumpers may be formed from several sheets of material or other manufacturing processes such as extrusion and molding. The sheet is folded along the bend lines and fastened into a closed structure with external or integral fasteners, adhesives, welding, or other fastening methods. Such fastening methods are described extensively in the related applications referred to above.

Front beams 42 lie aft of the front bumper. The front beams join to the bumper by front beam-bumper flanges 88. In an exemplary embodiment, the members are joined together through a rivet-bond and adhesive. Other fastening methods may be employed depending on the application requirements.

In an exemplary embodiment, the joint between the front beams and front bumper includes optional T-shaped patch plates 89. The patch plates fasten to the front beams and bumper to further secure the joint. Although the patch plates serve to hold the two members together, patch plates 89 primarily maintain alignment between the bumper and beams. In the event of an impact, the patch plate maintains the bumper in alignment so that the compressive force is transmitted from the bumper straight into the beams. This is especially the case for impact forces at an angle. The top and bottom surfaces of beams 42 resist shear forces, but the beams may be subjected to extreme lateral forces if the bumper were to come out of alignment.

The front beams are formed from a single sheet of material 70b. The sheet of material includes four panel portions 84b corresponding to the four panels or sides of the folded beam. The panels are defined by bend lines 72b. The sheets of material further include bend lines at each end defining flanges 88b. Along the perimeter, two bend lines further define front beam connection flanges 88b′.

The front beams are formed by folding sheet of material 70b along the bend lines. The method of folding and sheet of material are similar to those disclosed in the above-mentioned applications, incorporated in its entirety herein. With particular reference to FIG. 8, the edges—bend lines—and corners along the perimeter forms a skeletal structure of the beam. Flanges 88b create an overlap to produce a skeletal structure with increased rigidity. As shown in an exemplary embodiment, the overlap increases the thickness of the material along one of the bend lines and panels adjacent to the bend line. The sheet of material may also be modified to create an overlap, skeletal structure along the other bend lines.

Front beams 42 fasten to tub 44 at one end. With conventional chassis, members are welded or bonded together. In the most typical case, each piece is individually bonded to another piece. Therefore, precision welding is critical to the joining process with conventional chassis. Additionally, the pieces to be joined must be of material types amenable to the bonding process. For example, a plastic piece generally cannot be welded to a steel tube. With the chassis and joining structure of the present inventions, however, joining may be accomplished by and among many different types of materials and manufactured parts. The precision folding technology of the present inventions eliminates the need for many joints and joining processes. Many sections of the chassis may thus be formed as discrete modular components and thereafter joined with conventional methods such as rivets.

In general, the components forming chassis 32 may be joined together in a variety of configurations. Referring to each side of the components as panels, the components may be joined panel-to-panel or with an open configuration. In the panel-to-panel configuration, a panel of a first component member lies substantially flat against a panel of a second component member. When joined together, the adjoining panels form a rigid backbone to the joined structure. In an open configuration, at least one of the component members has an open side that aligns with the other component member. Adjoining component members may be joined in various other configurations either directly or indirectly. The joined member may also share less than a full panel surface in common such as common edge or corner. The members may also be joined through an intermediate member. Depending on the application, other joining configurations may apply.

In an exemplary embodiment, front beam-tub flanges 88b″ provide a fastening surface to the tub in an open configuration. The flanges fasten to a front surface of firewall 46. The beams may be provided with a closed end, for example by an end flap along another bend line, to increase the fastening surface area. In an exemplary embodiment, the firewall surface is configured to align with the end of the beams. In particular, the angle of the firewall substantially matches the angle of the end of the beams when joined thereto. Other configurations are also envisioned included a slot for receiving the beams.

In an exemplary embodiment, firewall shroud 60 wraps around the connection between firewall 46 and front beams 42. The shroud is formed from a single sheet of material folded along bend lines much like other members of the chassis. A top surface 91 of the shroud extends from a top of the firewall to the front beams (best seen in FIG. 5a). A side surface of the shroud forms flare 82 between the firewall and rocker beams at one end and the front beams at an opposite end. In an exemplary embodiment, along the bottom of the chassis, the bottom surface of the front beams extends in substantially the same plane as the bottom of the firewall. A bottom surface of the shroud wraps around a portion of the bottom surface of the front beams and over the joint between the beams and firewall thus increasing the strength of the joint.

With specific reference to FIGS. 10-13, firewall 46 is formed from a sheet of material 70d. The sheet of material includes a plurality of bend lines defining panels 84d and flanges 88d. The sheet of material is configured to fold along the bend lines to form the three-dimensional firewall illustrated in the various figures. An exemplary folded firewall includes a front face 93, side beams 95, and instrument panel portion 96. In an exemplary embodiment, these portions are all integrated into the firewall. Specifically, the information relating to the geometry of these portions is input into sheet of material 70d via the folding technology.

In the folded configuration, firewall 46 includes a skeletal structure similar to front beams 42. In an exemplary embodiment, the firewall includes material overlap along the joint between side beams 95 and instrument panel 96. As shown in FIG. 10, the firewall also includes several other areas of material overlap along the joints, fastening lines, and perimeter of the firewall. In an exemplary embodiment, a portion of the firewall is filled with a filler material after the firewall is formed. Such filler materials include, but are not limited to, expandable foam and epoxy.

The firewall is configured to join with several other members of the chassis and vehicle body. Side beams 95 include apertures 49 configured to receive an A-pillar or other structural member to support a windshield and roof rails. An exemplary firewall is configured to receive and route electrical components such as wiring harnesses. Because the firewall structure is essentially hollow, the wiring harnesses may be routed through apertures 49 and up to the instrument panel. Similarly, the firewall and other chassis members may be configured for any number of other applications.

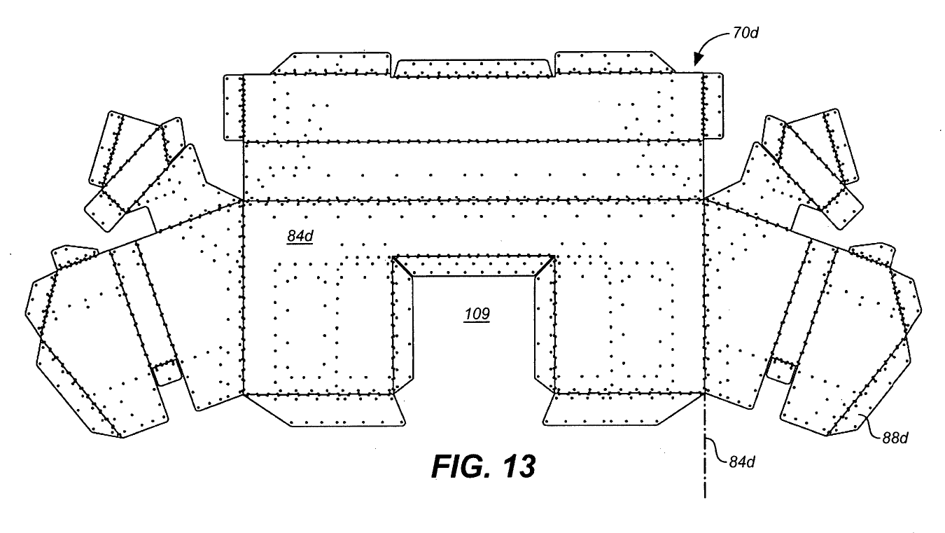

Firewall 46 and shroud 60 of an exemplary chassis are configured to increase rigidity in addition to their functions as mounting members and the like. With reference to FIGS. 14-15, shroud 60, instrument panel 96, firewall face 93, and an end of the front beam form a network of panels in a truss configuration as described above. Forces are effectively transferred into the system through the use of flanges and other structures. For example, the shroud includes a flange that secures it to the front beam. Each end of the instrument panel is connected to firewall side beams 95, which in turn run down to rocker beams 61. The use of overlap configurations and orientation of the panels with respect to each other in accordance with the present inventions provides a significant increase in rigidity without efficient use of materials and a small bill of materials.

Tub 44 includes a nosecone 98 that provides a transition between the firewall and tunnel 81 in the floor. The nosecone is formed from a single sheet of material and joins to the other chassis members with flanges much like the members described above. The nosecone serves several purposes. The nosecone may provide a cosmetic covering at the front of the passenger cab over the transmission or other systems. The nosecone also increases the strength of the chassis, in particular, the transfer of loading from the tunnel and floor to the firewall.

In an exemplary embodiment, the firewall is configured to receive and position the nosecone. The firewall includes a flange bend line just below the instrument panel that forms a crook into which a top surface 100 of the nosecone fits.

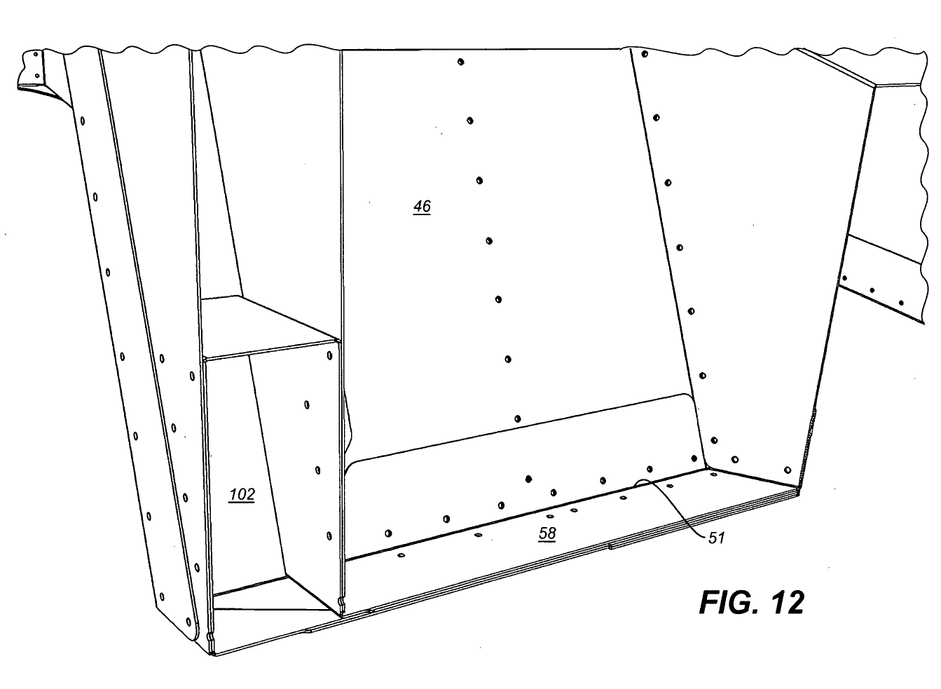

Turning to FIGS. 5C and 12, firewall 46 is configured to receive ends of rocker beams 61. The exemplary firewall includes nine mating surfaces joining the firewall to the floor section 58. The exemplary firewall is configured with rocker beam slots 102 dimensioned to receive the ends and rocker beam flanges 103 to fasten to the rocker beams. This configuration for joining the rocker beams to the firewall serves to improve alignment, rigidity, and ease of assembly and can be applied in other sections of the chassis as well.

In an exemplary embodiment, rocker beams 61 are not separate members of the chassis but instead are monolithically formed with at least a portion of floor 58. In an exemplary embodiment, tub 44 includes a floor section 105 comprising tunnel 81, floor pan 107, and the rocker beams. The floor section is formed from several sheets of material 70e folded and joined together. In the alternative, the floor section may be formed from a single sheet of material. In one embodiment, the floor section is single body having a cellular structure defined by a core 110 sandwiched between two substrates 112 (best seen in FIG. 26).

Sheets of material 70e of material are joined similar to the chassis members described above. The sheets further include floor joining flanges 88e that create an overlap configuration in the joining region to further secure the bent sheets together.

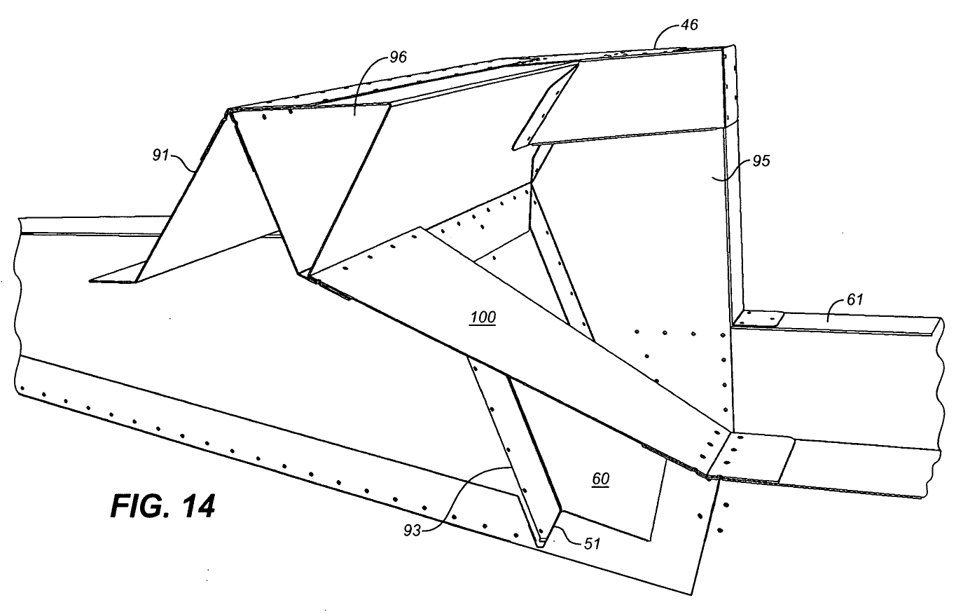

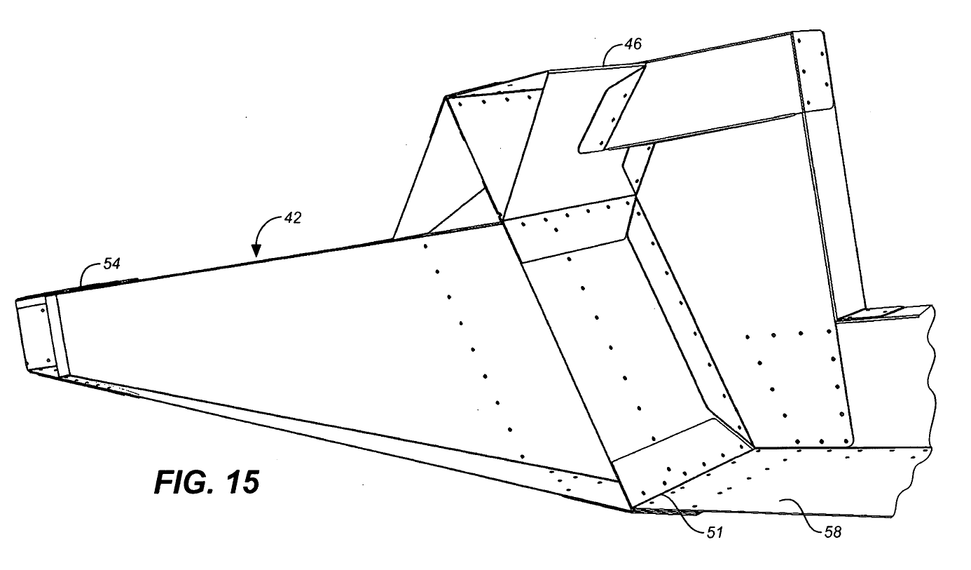

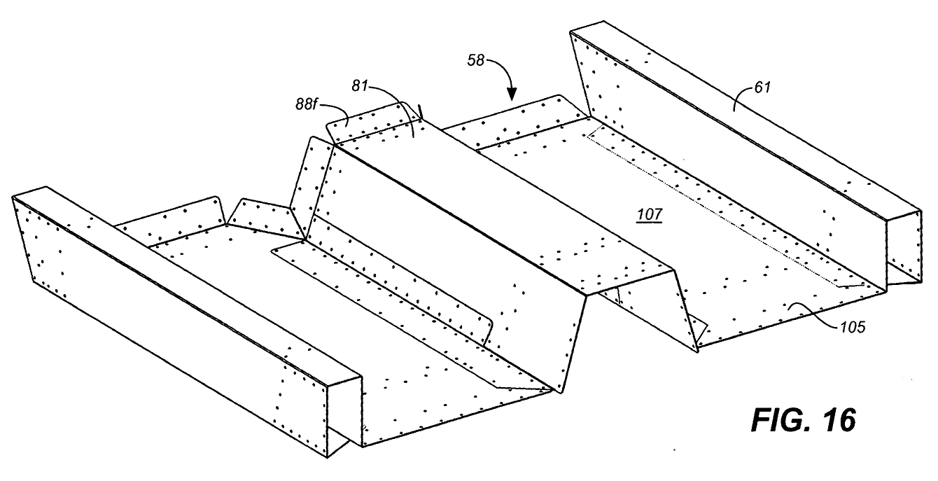

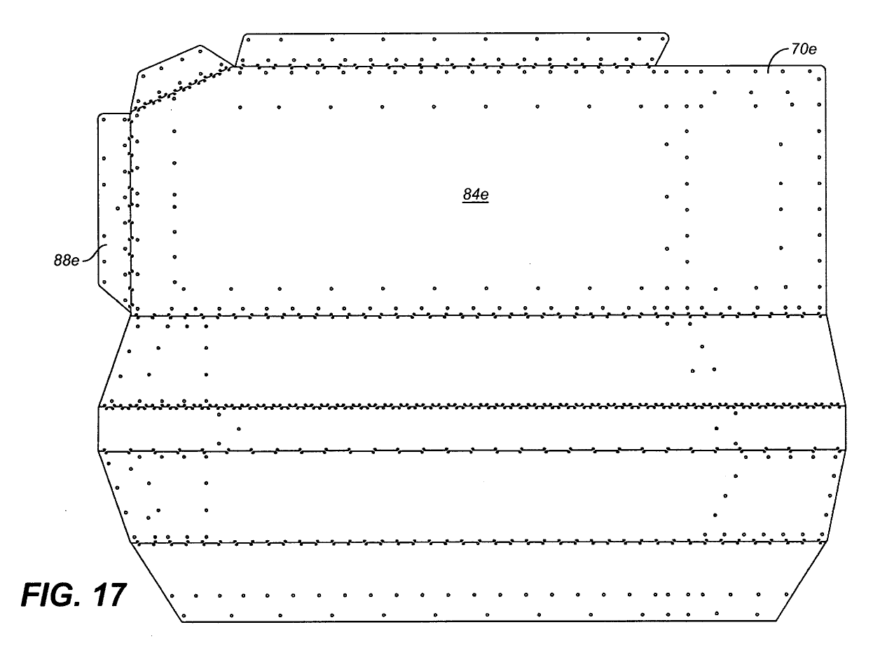

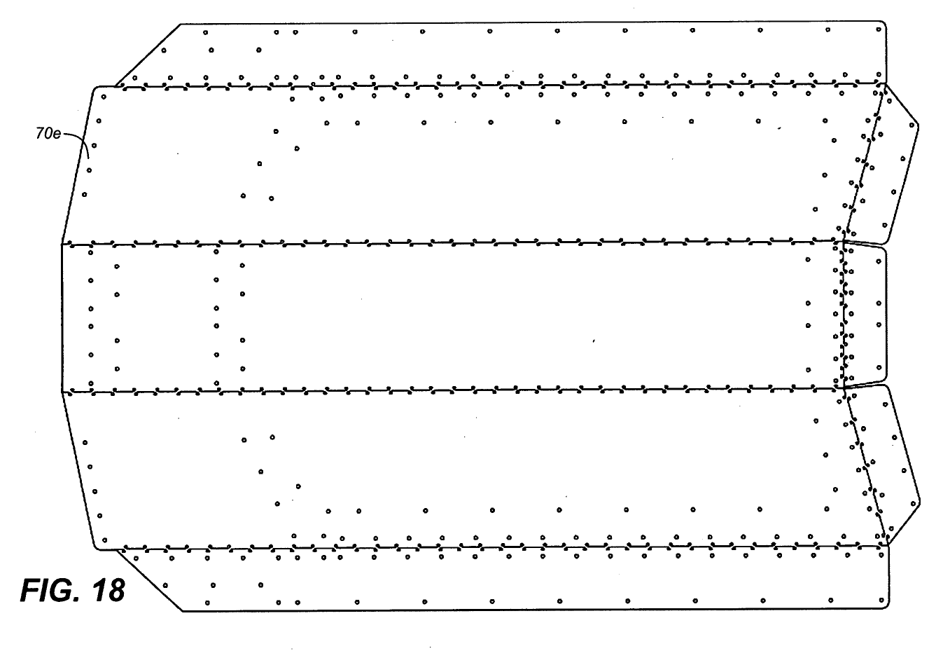

With reference to FIGS. 5C and 16, tunnel 81 runs longitudinally down the middle of floor section 105. The tunnel serves to cover a drivetrain in the case of front engine, rear drive vehicles. In contrast to conventional chassis tunnels, exemplary tunnel 81 also serves as a rigid structural member. An exemplary tunnel includes positioning structures and bend lines in accordance with the bending principles disclosed in the related application. It has been found that such bent structures increase rigidity. The tunnel further includes flange sections that secure the tunnel to firewall 46 in the front and bulkhead 47 in the rear. In an exemplary embodiment, the flanges also provide an overlap configuration to increase rigidity similar to the firewall.

In an exemplary embodiment, firewall 46 and bulkhead 47 are configured to receive and join with the tunnel. A bottom portion of the firewall includes a cavity 109 that is dimensioned and configured to match with the tunnel geometry. Thus, a front end of the tunnel fits with and is fastened to the firewall. The tunnel is further joined to the firewall by nosecone 98 and tunnel flanges 88f The bulkhead includes a similar configuration. In this manner the tunnel in conjunction with the rocker beams rigidly joins the bulkhead and firewall into a rigid lattice structure in the middle portion of the vehicle.

In an exemplary embodiment, tunnel 81 includes additional strengthening mechanisms (best seen in FIG. 19). The tunnel walls may be configured as structural walls. Similar to the floor, the walls may be configured with a cellular structure. In an exemplary embodiment, the top of the tunnel has a honeycomb-shaped core 110 sandwiched between two substantially planar sheets 112. The side walls of the tunnel have a laminate structure with a thin sheet 111 reinforced with a structural material 111′ depositing thereon. The tunnel in accordance with the above has increased longitudinal stiffness and adds a significant degree of lateral and torsional stiffness.

Additionally, tub 44 in accordance with the present inventions may optionally include supplemental members for increasing rigidity. In one embodiment, cross-members 114 extend laterally across the tub from door-to-door (shown in FIGS. 25 and 26). The cross-members are configured to increase the lateral rigidity of the chassis.

In the case of convertibles that do not have a roof section, the tunnel and rocker beams are often the only members that extends longitudinally along the middle of the vehicle. Furthermore, in some cases it may be desirable to have rocker beams with a shorter height or thinner width to make it easier to step over the door sill and gain entry to the vehicle. In these cases conventional chassis requires substantial modifications to the chassis. Such modifications include increased material in the A-pillar and C-pillar regions and strengthening of the floor with cross-bracing, additional thickness in the floor, and other methods. These methods increase manufacturing complexity, material cost, quality control issues, and weight. The tub section in accordance with the present inventions achieves sufficient rigidity without the use of such complex methods.

The rear end of chassis 32 is configured similar to the front end. Bulkhead 47 may be formed from one or more sheets of material similar to the firewall. Also, the bulkhead may be similarly configured to rigidly join with rocker beams 61 and tunnel 81. In an exemplary embodiment, the bulkhead may have a cellular structure similar to that of the tunnel.

A pair of rear beams 42′ join with the bulkhead in the rear of the vehicle. The rear beams are formed similar to the front beams. In contrast to the front beams, however, the exemplary rear beams have a mid-plane closing configuration. A sheet of material 70g includes rear beam flange ends 88g. The sheet is configured to fold such that the flange ends meet in the middle of one side of the resulting structure as opposed to along an edge. This configuration takes advantage of the fact that in many applications failure occurs along the edges of the structure. Failure is less likely to be caused by buckling of the plane. The same configuration may be used to form the front beams and vice versa.

The rear beams are joined with the bulkhead similar to the front beams. The joint lines on the top and bottom surfaces of the rear beams and bulkhead further include optional patch plates 89 to stiffen the joint. With reference to FIG. 22, it can be seen that the rear beams and bulkhead join together to form a rigid, aligned structure. In an exemplary embodiment, the tunnel can be seen to further brace a front wall of the bulkhead against buckling under compressive loads from the top of the rear beams.

Many of the above-described features blur the line between structural and aesthetic members. For example, shroud 60 may be configured to support an instrument panel 96 while at the same timing serving as a significant structural member of chassis 32.

Each section of chassis 32 may include a three-dimensional structural member formed from a sheet of material have a plurality of bend lines. Each bend line is defined by a plurality of positioning structures as described above. In one embodiment, the chassis section further includes a plurality of nodes with each node positioned along one of the plurality of bend lines. Each node in turn defines a geometrical feature of the structure. In one embodiment, a junction between at least two of the plurality of bend lines is configured and positioned to define one of the plurality of nodes. The junction may be defined by an intersection of at least two bend lines or an intersection of adjacent panels, tube-like members, or the like.

As discussed above, an exemplary chassis is composed of several separate component members joined together. The general method of joining these chassis members may now be described more broadly.

In one embodiment, at least one of the chassis members is formed from a sheet folded along bend lines. A second member is joined to the folded first member. The two members may configured to join together to form a node of the chassis. In one embodiment, the bend lines of the first member, and optionally the second member if it includes bend lines, defines a plurality of geometrical features of the resulting section of the chassis formed by the joining of the two members. The chassis members may be also be joined in other configurations. In one embodiment, the chassis members join together to form a unibody chassis construction.

The chassis members do not need to be joined end-to-end or with a common line or edge of engagement either. In one embodiment, a first chassis member is wrapped by a sheet of material having bend lines. The bend lines may correspond to desired geometrical features of the resulting vehicle or chassis, such as curves and inflections in the body architecture. Alternatively, the bend lines may correspond to physical edges of the first chassis member to be wrapped. Such a configuration allows for nesting or wrapping and can be used to increase rigidity, create complex shapes, and other applications. Other configurations may also be employed depending on the application.

In addition to chassis 32, a typical motor vehicle includes many other stationary and working assemblies. Vehicle 30 includes several component members and subassemblies in connection with the chassis (best seen in FIG. 1). Although described as separate members, such assemblies and members may also be formed with and considered part of the chassis. The method of joining these members together will now be described.

The component members may be secured together by several methods. Such methods include, but are not limited to, adhesives, welding, mechanical fasteners such as rivets, and/or other suitable fasteners. In an exemplary embodiment, chassis 32 employs several joining configurations. For example, in the front of the chassis, shroud 60 includes at least one aperture configured to receive ends of beams 42. The apertures serve to align and hold the beams in position at least temporarily until permanently joined together. Several component members include joining flanges 88 configured to fasten the two components together.

In one embodiment, at least one structure serves secondarily as a fastener for two distinct components. In an exemplary embodiment, front tower rails 39 are connected at one end to the front of beams 42 and at an opposite end to at least one of shroud 60 and firewall 46. Therefore, although the primary function of the front rails may be to support suspension towers 40, the front rails serves the secondary function of supporting and joining together front beams 42 to the rest of the chassis.

In an exemplary embodiment, beams 42 are joined together cross-wise by bumper 53. The bumper is joined to the end of the beams through the use of several joining techniques. The bumper and beam are joined together through the use of flanges and/or adhesives similar to the joining of the beam to the shroud. Further, joining flanges 88 on the beam include rivet holes for rivet-bonding to the bumper.

It should be noted that the size, shape, and configuration of joining flanges 88 will vary depending on the application. Accordingly, the flanges to attach beams 42 to bumper 53 vary from those configured to attach the beams to tub structure 44. In one embodiment, the flanges are further configured to provide a smooth transition between panels of adjoining components. In an exemplary embodiment, the junction between transmission tunnel 81 and firewall 46 includes flanges with an angle of incidence intermediate that of the tunnel and firewall. Additionally, the flanges may be configured to reduce stress at the junction between components. The flanges may have a larger shape or outer dimension to direct stress away from the zone of engagement of the two components. The method of securing the flanges and the like should also be taken into consideration. By way of example, the flanges may be configured to advantageously move rivet holes away from the connection between the components.

In an exemplary embodiment, the joining of the two components is further reinforced by the attachment of at least one patch plate 89. Multiple plates may be provided in a stacking structure. The two plates may be configured to reinforce the joint between the components with differing shapes, thicknesses, and the like. Each plate is optionally fastened to the two components independently of the other plate.

It should be noted that the above joining methods generally relate to permanent joining of members. However, depending on the application, it may be desirable to releasably join members or only temporarily join members. Furthermore, folding and manufacturing technologies described may be employed for self-fixturing processes upstream of a final forming station as will be described in greater detail below. A conventional method employs fixtures to hold parts in position. In one embodiment, the first and second component members are joined together without the use of fixtures and similar mechanisms.

### Structures and Materials of Exemplary Chassis

Several strengthening features have been described above in relation to particular chassis members. Such features will now be described in more detail below in regards to the entire chassis 32.

As described above, floor 58 includes a cellular core 110 sandwiched between film structures 112. In an exemplary embodiment, the cellular core is a sheet of material bent along bend lines into a corrugated sheet and sandwiched between two sheets of material. The core may also be configured with alternative structures. In an exemplary chassis 32 at least one of the components includes a sandwich structure with a honeycomb-shaped core.

The bulkhead may be filled with a filler material 117 (see, e.g., FIG. 22). This principle may be applied to any number of three-dimensional hollow structures to increase rigidity with little added weight and complexity. A filler material may also be placed in other structures for safety. For example, filler material may be added to the bumper for compressive strength and energy absorption. Suitable materials include, but are not limited to, expandable foam, compressed air foam, foam inserts, and resins, but other materials may be appropriate depending on the application. The filler material may be applied inside of three-dimensional components after bending from a two-dimensional sheet. The filler material can also be applied in other components such as within the cells of cellular structures such as exemplary floor structure 58. The foam may be placed in only a portion of the component, such as the region of a bend line, or throughout the component. The use of such a filler material provides another way to increase the rigidity and strength of components of chassis 32.

As with most any dynamic structure, chassis 32 may experience forces from harmonics. The presence of many planar sheets in the structure may lead to increased stress on the structure. In one embodiment, filler material is placed inside of at least one member of the chassis such that the natural harmonic is dampened. Other dampening configurations may be used depending on the application.

In an exemplary embodiment, tunnel 81 includes laminate panels. Each laminate panel includes a substrate with a structural material 116 deposited on the substrate surface. In an exemplary embodiment, the substrate is a non-compressible sheet of material having bend lines and the structural material covers at least the bend lines. The substrate is bent along a desired bend line into a three-dimensional structure. Either before or after bending, the structural material is deposited to the substrate. Thereafter, the structural material is allowed to cure thus forming a rigid structure with laminated panels and stiffened bent edges. The laminate structure thus has at least two layers: a first layer with a bend line and a second layer of the structural material. The layers do not need to be substantially flat. Depending on the application the shape and configuration of the layers may be modified.

The laminate may be manufactured “in situ.” In one embodiment, the sheet of material 70e is folded along the bend lines and positioned in a mold or similar device. Thereafter, the structural material is deposited on the sheet. In such case, the structure may be formed with a fastener 115 integrally connected to the sheet of material by the structural material, the fastener being positioned relative to the sheet prior to application of the structural material as is shown in FIG. 19.

The presence of the rigid structural material over the bend line provides the additional benefit of preventing flutter. Flutter refers to lateral movement of one of the bent sides relative to the other bent side and results generally from stretching and compressing of the bending webs or straps along the bend line.

Structural material 116 for the laminate may be a variety of different materials. Suitable materials include, but are not limited to, adhesives, polymers, resins, wood, and composites. In an exemplary embodiment, at least one panel of the bulkhead carbon fiber is used as the structural material.

In one embodiment, the structural material is further configured to seal the bend line. Sealing refers to water resistance, electromagnetic shielding, prevention of other tangible or intangible matter from passing through the bend line after bending, and the like. In one embodiment, structural material 116 is configured to fill gaps in the bend line formed by the bend-facilitating structures.

Structural material 116 may also be a rigid material placed over a bent substrate sheet. In this case, the structural material is formed from a sheet of material bent about a bend line. The sheet may positioned along the substrate before or after bending such that the substrate bend line and structural sheet bend line are substantially aligned.

The structural material and substrate form a rigid, layered, bent structure referred to herein as a laminate panel. The resulting structural having a laminate bend line and/or a partially laminated panel side is referred to herein as a laminate structure. The resulting laminate structure is joined to the rest of chassis 32 similar to other components as described above.

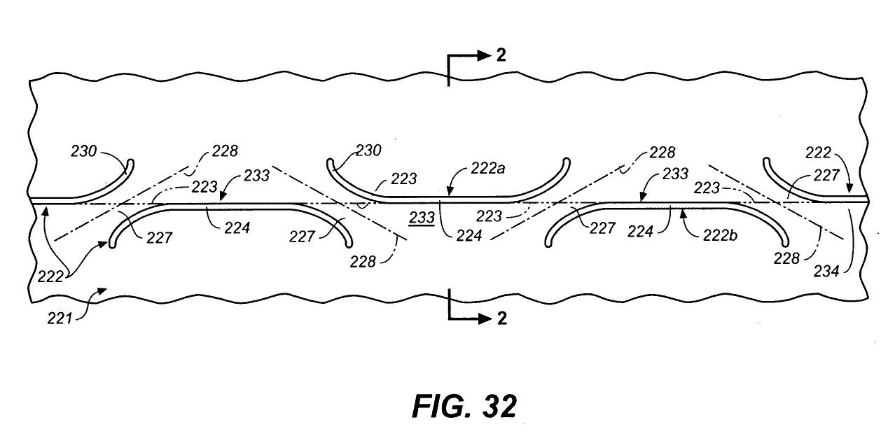

In one embodiment, the structural sheet of material includes at least two bend lines configured to create a gap between the structural sheet and the substrate bend line. The gap is then filled with a filler material. In one embodiment, a quilted corner is filled with filler material. Suitable filler materials include, but are not limited to, foam, compressed air foam, resin, adhesive, wood, polymers, and epoxy. The resulting laminate may also be filled with a filler material as described above. As will be appreciated from one skilled in the art from the foregoing, various components of chassis 32 besides tunnel 81 and floor 58 may be prepared with laminate structures, filler materials, and the like. Further details regarding such materials and structures in accordance with the present invention will be described below with reference to FIGS. 32-41.

Additionally, the components and sections of chassis 32 may optionally include treatments depending on the application. Such treatments include, but are not limited to, adhesives, coatings, and physical structures. For example, in some applications it may be desirable to apply a water sealant or paint to the bend line or an entire panel after folding. Further, a filler material may be optionally applied between the substrate bend line and structural material bend line.

Structures and configurations similar to the floor and bulkhead described above may be employed throughout chassis 32. A combination of these structures may also be employed. For example, firewall 46 may be formed with laminate sides and a cellular core. The structure may be further modified with optional structural fillings and treated with coatings and the like.

Generally, the chassis of the present inventions results from use of any number of the above described structures in various portions. Different considerations will drive the design of individual components, subassemblies, and larger sections of the chassis. Therefore, the particular configuration used in any area will often vary from another area of the chassis.

As will be understood by one skilled in the art, the configuration of the floor, tunnel, cross-members and many other components of the chassis requires consideration of many factors such space requirements, loads and performance characteristics, and cost. For example, some vehicles may limit the space for seating and/or have lower stiffness requirements such that cross-members 114 and the like are not employed. It will be understood by the above that the chassis and component members may be modified and adjusted in accordance with the present inventions in view of many such considerations.

Similarly, the chassis configuration may be modified in accordance with loading requirements. In one embodiment, a suspension loading point is located inside of beams 42. Likewise, the volume inside of all of the three-dimensional folded structures may be utilized for a varying of applications.

As describe above, chassis 32 may be formed of a variety of materials and structures utilized and joined in myriad fashion. Referring to FIGS. 32-42, various components of the chassis, body, and vehicle components may include a laminate structure.

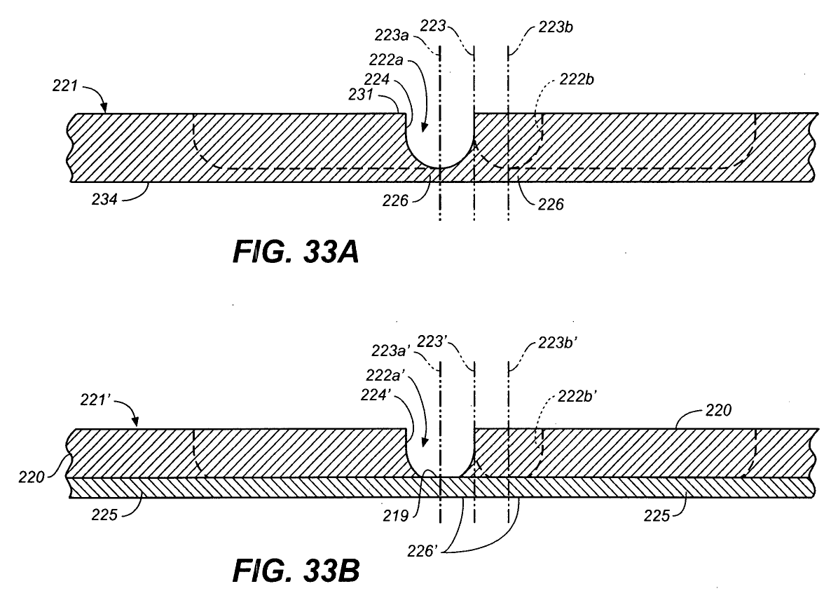

FIG. 33B illustrates an exemplary laminate sheet 221′ including a sheet of material 220 and a layer 225 which may be used in chassis 32. Sheet 220 includes a bend line 223′ and acts as a control layer. The bend line and bend-controlling structures described herein are similar to those described above. Sheet 221′ is comprised of an upper sheet or layer 220 to which a lower sheet or layer 225 is adhered, bonded, laminated or otherwise affixed, for example, by an adhesive, fasteners or thermal bonding process. Layer 225 may also be affixed to the top of sheet 220. Layer 220 could, for example, be a sheet of a material having poor ductility, such as a brittle fiberglass or plastic, while layer or sheet 225 could be a very ductile sheet or layer, such as a ductile, low-tensile strength metal or vice versa.

Layer 225 may be affixed or adhered to sheet 220 in various ways. In various embodiments, only part of layer 225 is affixed to sheet 220. For example, only a portion of layer 225 adjacent to the bend line may be affixed to sheet 220 and the rest of laminate sheet 221′, including the bend line area, is left free. In such a case, a pocket may form between the bend-controlling structures and layer 225, such as a space between a displaced portion of the sheet and an adjacent portion of the layer. Laminate sheet 221′ may be configured to account for spring-back in sheet 220, for example, layer 225 may be an elastic material to accommodate variations in the bend angle.

Sheet 220 is shown with bend-controlling displacements 222a′ and 222b′. In various embodiments, the bend-controlling structures are grooves which have been chemically etched into a metal or plastic sheet. When the etching process reaches the top surface 219 of sheet 225, etching can be stopped, for example, by neutralizing the etching chemicals or by the adhesive layer which bonds layers 220 and 225 together, or by the chemical inertness of the material of layer 225, as compared to the chemical reactivity of layer 220. Grooves 222a′ and 222b′ correspond to grooves 222a and 222b in FIGS. 32 and 33 and have groove bend lines 223a′ and 223b′ with sheet bend line 223′, as described above for FIGS. 32 and 33.

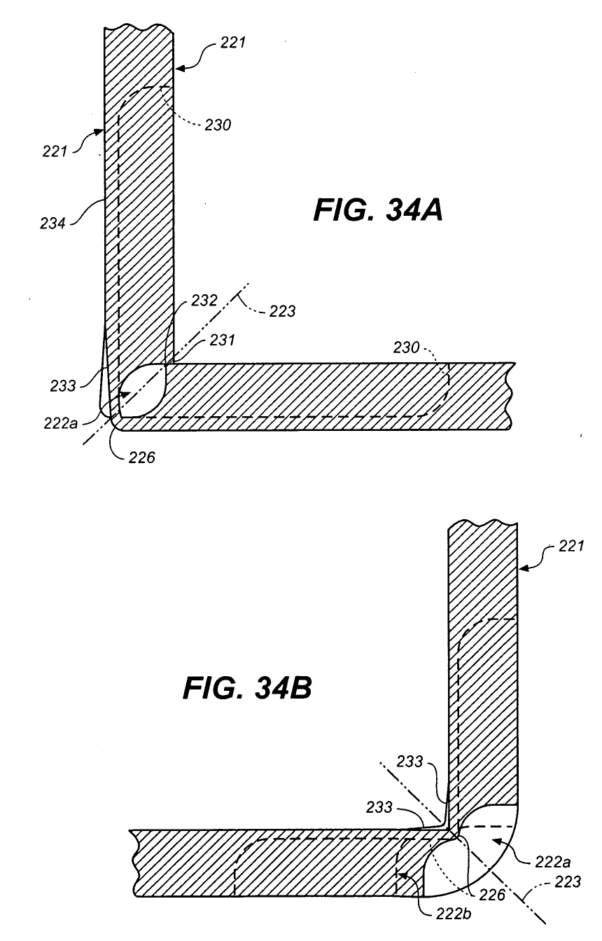

The grooved laminate sheet 221′ may have bending webs 226′ that are ductile and facilitate bending in the same manner as shown in FIGS. 34A and 34B only the sheet will be a laminate structure.

Laminate sheet 221′ of FIG. 33B may also be grooved or slit using any or all the techniques set forth above instead of etching. Various combinations of materials can be laminated together to produce various strength, ductility, conductivity, erosion resistance, aesthetic and other effects which may not be easily achieved when a single layer of material is used. Laminate sheet 221′ also may have, as one form, the mere adherence of a layer of a flexible coating 225, such as, a paint, epoxy, dip brazing layer, etc., which again can have advantages when layer 220 is relatively thin. In various embodiments, layer 225 may be configured as a thin film. Control sheet 220 may also be configured as a thin film.

Referring generally to FIGS. 33B and 35-41, sheet 220 may be configured as a control surface whereby sheet 220 primarily controls the bending process. For example, layer 225 may be a flexible material or of a configuration that bends easily and sheet 220 of a rigid material. Thus, during bending, the rigid sheet and bend line precisely define where bending occurs. Layer 220 may be a material providing resistance to bending, for example, to provide tactile feedback or to further control and facilitate bending.

In various embodiments, layer 225 is selected and/or configured to provide aesthetic characteristics or to protect sheet 220. By example, larger bend-facilitating structures such as displacements lead to discontinuities in the outer surface after bending. Such discontinuities may be more readily apparent with sharper bends than smooth curves. Layer 225 may be selected to provide a smooth, protective outer surface over the bend line in sheet 220. As shown, for example, in FIG. 42, layer 225h provides a smooth outer surface to bent sheet 220h. Such a surface may be desirable in applications where the bend line would otherwise be visible or an additional layer, such as paint or a cosmetic surface material, is to be applied.

Suitable materials for layer 225 include, but are not limited to, silicone, neoprene, flexible metals, and rubber. In various embodiments, the material of sheet 220 has a higher strength and/or lower ductility than the material of layer 225. The layer may have different characteristics depending on the application. For example, layer 225 may be a transparent material to provide visual cues of sheet 220 underneath. Similar materials may be used for sheet 220 as sheet of material 221, but the laminate structure described herein provides greater flexibility in choice of materials and configurations. Layer 225 and sheet 220 may also be the same material depending on the configuration. For example, sheet 221′ may be formed from a layer of thin metal laid over a thick piece of the same material. In various embodiments, sheet 220 is at least twice the thickness of layer 225.

Layer 225 and/or sheet 220 may be treated and prepared to suit particular applications. In various embodiments, layer 225 and/or sheet 220 have integrated color (e.g. color dye) prior to forming of laminate sheet 221′. In various embodiments, the laminate sheet is finished before or after bending. Finishing may include spot welding, sealing, polishing, sanding, and the like of the bend line or outer surface after folding.

While laminating is described as a step prior to forming the bend-controlling displacements, it will also be understood that layer or sheet 220 can be cut through to form slits and layer 225 laminated or adhered to layer 220 after the slitting occurs. This converts the slits to grooves in which there is a continuous membrane or web 226 across the bottom of what was slits. Laminate sheet 221′ also could have more than two layers, and grooves 222a′ and 222b′ could penetrate less than all the way through upper layer 220 or into lower layer 225, depending on the bending effects desired.

Sheet 220 may be provided with various bend-controlling structures as noted above. Bend-controlling structures 222a′ and 222b′ may be slits, displacements, grooves, and similar structures. The bend-controlling structures may also be mere gaps in the material or similar areas of weakness that promote bending. In such a case, the layer may be configured to hold and pull the sheet together across the area of weakness.

The bend-controlling structures may be formed by laser cutting, water jet cutting, punching, stamping, etching and other processes as would be understood by one skilled in the art from the foregoing description. Such processes for forming bend-controlling structures are described in depth in U.S. Pat. Nos. 6,481,259, 6,877,349, and 7,152,449, all of which are incorporated herein for all purposes by reference thereto.

The bend-controlling structures may be formed prior to forming the laminate sheet or after preparing the laminate sheet in the flat. For example, laser cutting techniques or other techniques may be used to create a bend-controlling structure in sheet 220 through layer 225.

In the case of a laminate sheet with a flexible, elastic outer layer 225 and hard sheet 220, the bend-controlling structure may be punch or cut through the layer 225 without piercing the layer. The sheet 220 may also be provided on top of layer 225, which provides easier preparation of sheet 220, or laminate sheet 221′ may be formed and prepared “upside down” and flipped over during assembly.

The process of forming bend-controlling structures and the type of structure may depend on the application. It has been found, for example, that laser cutting provides a smoother surface than punching and thus may be more desirable in applications where a smooth outer surface is desired and the bend-controlling structure is not adequately masked by layer 225.

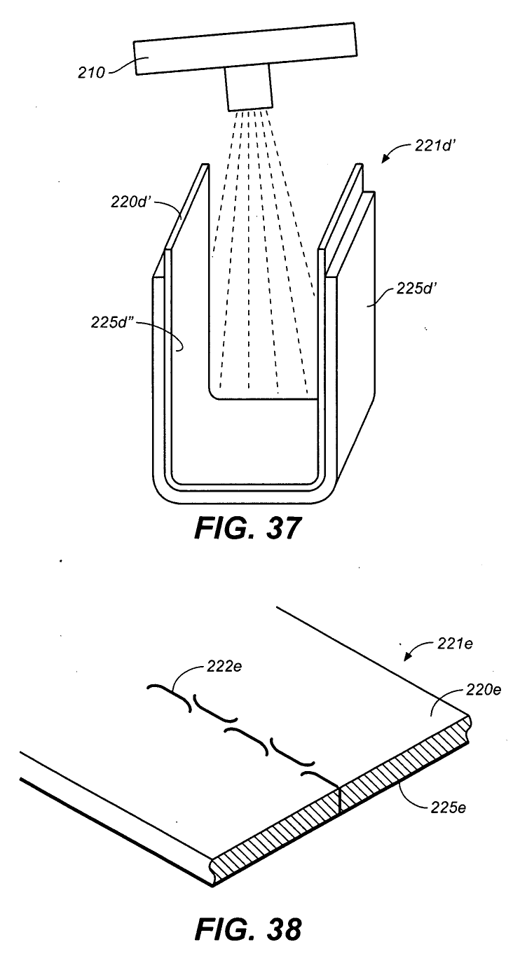

Laminate sheet 221′ may also be formed with multiple layers (shown, e.g., in FIG. 35A). An additional layer may be provided as a reinforcement layer. For example, sheet 220 may be sandwiched between an aesthetic layer and a reinforcement layer. Similar to layer 225, the additional layer(s) may be added before or after bending. Post-bending application may be desirable in instances when the layer to be applied does not lend itself to bending, such as when a layer of carbon fiber composite, plastics, or another suitable material is to be applied in situ to the inside of the bend line and/or sheet 220b (shown in FIG. 37). The orientation may also be altered to impart desired characteristics, such as by orienting fibrous materials (e.g. carbon fiber) to increase strength of sheet 221b′.

Referring to FIGS. 35A-35C, a laminate sheet 221c is shown forming a component of a larger assembly, in the illustrated example, an automotive vehicle. The laminate sheet 221c is similar to sheet 221′ and includes a sheet 20c sandwiched between multiple layers 225c and 225c′. Layer 225c′ is a layer of thin film such as an overcoat provided for cosmetic and protective purposes. Sheet 221c includes a bend line 223c. The bend line may be a smooth, curved shape or may have various other shapes depending on the design and structural specifications. After bending, bend line 223c defines an inflection line in a curved surface (best shown in FIGS. 35B and 35C). In this manner, laminate sheet 221c may be prepared for bending with compound curved surfaces and edges similar to laminate sheet 221′ and sheet 220 described above.

FIG. 36 illustrates another example of a laminate sheet 221d similar to sheet 221c. Laminate sheet 221d includes a bend line 223d that defines a subtle bending curve. As seen in FIG. 36, in bent form, the bend line does not define a distinct line or edge in the sheet but rather defines a smooth transition, in this case a transition from a side panel to an orthogonal hood panel.

Referring to FIGS. 37-42, various examples of laminate sheets for use in chassis are shown. As shown in FIG. 37, a layer may be provided in situ on the inside of the bend line in the control sheet. One will appreciate that various means may be utilized to apply suitable materials in situ. For example, the material may be applied using processes such as spraying, molding, brush application, and the like. In one embodiment, a spray nozzle 210 applies a coating or layer 225d″ on the inside of the sheet 220. A flexible layer 225d′ is positioned around the sheet, either before or after bending.

Referring to FIG. 38, the bend line 223e may be defined by positioning or bend-controlling structures. In the various embodiments, the bend-controlling structures are slits having a central portion substantially parallel to the bend line and end portions diverging away from the bend line. The bend-controlling structures are further configured with stress-reducers. In one embodiment, the stress reducers are return portions at each end of the bend-controlling structures which return back towards each other and then curve back toward the bend line.

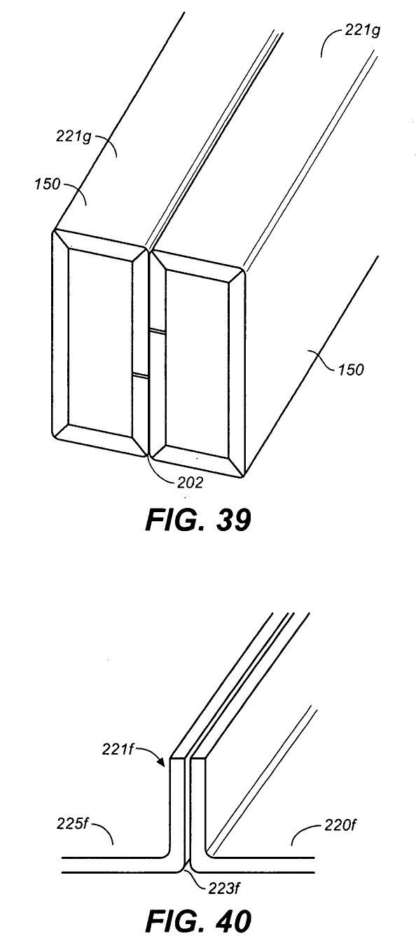

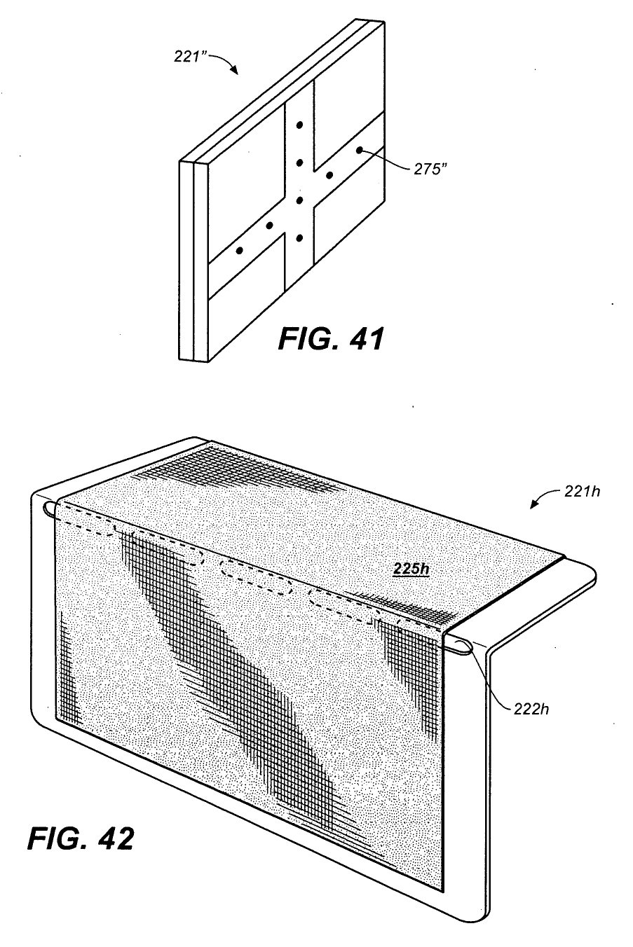

As shown in FIGS. 39-41, laminate sheets in accordance with the present invention may be used to form various bent structures and in various configurations. FIG. 39 depicts a sheet of material 221g folded into three-dimensional, tube-like structures 150 which are positioned adjacent one another. Sheet 221g may be two laminate sheets or a single-layer sheet. The three-dimensional structures form an area of overlap 202 which provides many of the benefits of a laminate structure. The sheets may be adhered together along the area of overlap or may be left free. FIG. 40 illustrates two sheets 220f, 225f that converge at a bend line. The sheets form a laminate structure 221f on one side of the bend line, and the laminate structure may be adhered together as described above. FIG. 41 illustrates a laminate structure 221″ formed from two sheets of material held together by fasteners 230″.

FIG. 42 illustrates a laminate sheet 221h formed from a sheet of rigid material 220h and a layer of material 225h. The rigid material 220h includes a bend line defined by a plurality of bend-controlling displacements 222h. The processes for forming bend-controlling displacements 222h are described in depth in U.S. Pat. No. 7,152,450, which is incorporated for all purposes herein by reference thereto. As described in the '450 application, bend-controlling displacements may be formed by displacing material out of the plane of the sheet. Displacements provide several advantages, but such displacements are generally more visible than slits, grooves, and the like. Accordingly, it may be desirable to position a layer over the side of the bend line and displacements that will be visible to consumers. It has been found that some materials better mask the underlying displacements.

The selection of materials for the layer or use of additional layers may be based in part on a desire to mask bumps, colors, and other imperfections in underlying surfaces. For example, an opaque or more rigid material may be used for such cosmetic purposes.

Layer 225h is a flexible material such as neoprene that covers the bend-controlling structures after bending (best seen in FIG. 42). Thus, the laminate sheet 22 1h provides the benefits of precision bending without sacrificing cosmetics. In the illustrated embodiment, the layer 225h includes an adhesive backing such that the laminate structure can be formed cheaply and easily.

### Method of Making

The method of manufacturing the chassis in accordance with the present inventions in comparison to conventional chassis will now be described. With conventional chassis manufacturing systems, each individual piece of the chassis to be formed is positioned and then held in an initial position by a fixture. Thereafter the piece is welded by a machine or by a skilled worker. In order to keep parts within specified tolerances, the system takes constant measurements and adjusts the manufacturing process to maintain the nominal geometry. This process of defining the geometry, setting the tolerances, and making adjustments are commonly referred to as geometric dimensioning and tolerancing (GD&T). Conventional chassis also require assembling in a particular order and post-assembly machining including milling, grinding, bending, and welding. The present invention allows for tighter tolerances and more accurate positioning to alleviate the need for constant adjustments, use of fixtures, and post-assembly machining. The sheet preparation techniques described in the related applications referenced above allow for precision bending of sheets of material.

In one embodiment, the above-described processes are employed to optimize self-fixturing processes. Conventional chassis fabrication systems include at least one station for fabricating parts and sections of the chassis. The precision bending techniques of the present invention allow for self-fixturing of structures, subassemblies, and the like. Conventional systems make use of part geometries for fixturing at the part-level, but such systems do not make use of such fixtures at the larger subassembly and global vehicle level. For example, fixtures make be built to position an individual part such as a tube based on known geometry. When this part is then welded to another part, however, errors in the process begin to accumulate. The methods of the present invention allow for precision bending whereby part positions can be accurately determined. Moreover, the methods of the present invention include joining methods for forming larger sub-assemblies.

Simple fasteners such as those described above and in the related applications may optionally be used to temporarily or semi-temporarily affix the sub-assemblies together until they are permanently fixed at a conventional forming station. In this manner the methods of the present invention allow for optimized self-fixturing integrated into a conventional chassis manufacturing line. For example, self-latching tabs 119 may be provided on one subassembly to secure a flange or other portion to an adjacent panel of another subassembly, as is shown in FIG. 5B. Such self-latching tabs may similar to that shown in U.S. patent application Ser. No. 11/386,463 and now US 2006/0277965 A1 to Durney and/or other suitable self-latching structures. Once such self-latching tabs affix the relative orientation of subassemblies, suitable fastening means such as rivets, spot welding and the like may be used to permanently and/or securely affix the subassemblies together.

In the alternative, the sub-assemblies may be permanently fastened and fixed in accordance with other principles and methods described such as by adhesives. Further still, the subassemblies may be initially secured by suitable means, for example, by one or several rivets. Such initial assembly allows one to leverage the tolerances and precise alignment information applied to the sheet material which would force alignment of the subassemblies with respect to one another and thus align the remaining rivet holes, and thus facilitate subsequent permanent assembly by applying the full accoutrement of rivets.

Because, the chassis architecture may be expressed in terms of panels or sides, lines, corners, and the like, information regarding the chassis may be input into the two-dimensional sheet in the flat. “In-the-flat” refers to designing the three-dimensional structure to be formed, whether the entire chassis 32 or subcomponents, and then laying out the resulting structure in a flat two-dimensional sheet. By designing in-the-flat, the features of the three-dimensional can be positioned and configured in the sheet. Because positioning structures 74 facilitate simplified, accurate bending, the information in the sheet is accurately translated into three-dimensions upon folding. In one embodiment, at least one of the geometrical features of the chassis to be formed is laid out in two-dimensional sheet.

The high precision of the above described folding and assembling technologies also allows for greater flexibility in chassis manufacture. Components, assemblies, and modules may be assembled separately and in any order because the constant measurements and adjustments are not necessary.

Although described in terms of the chassis, other members of the vehicle may be formed in accordance with the present inventions. Such members may further be integrated and joined with the chassis. For example, the chassis may be optionally provided with a seat structure.

### OTHER EXAMPLES

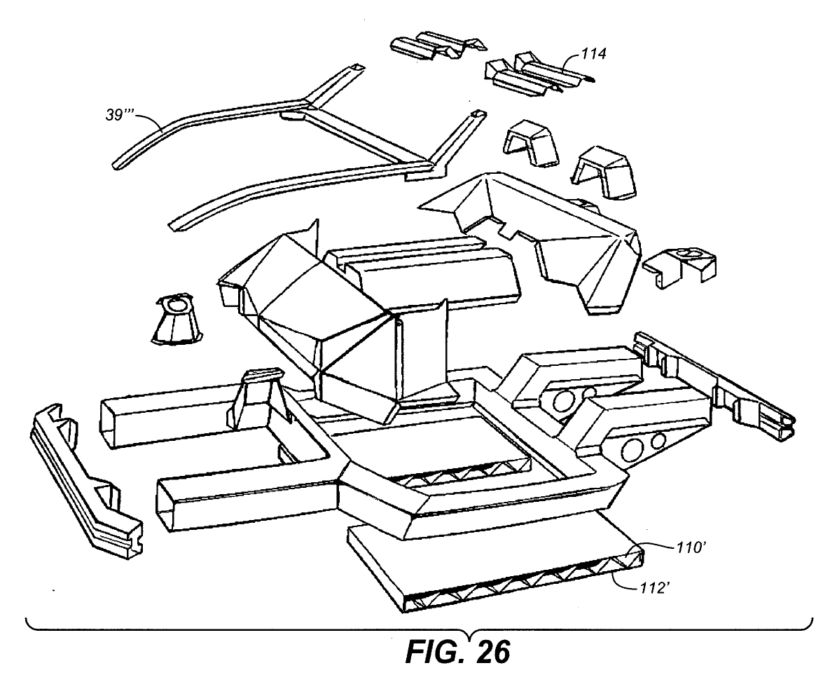

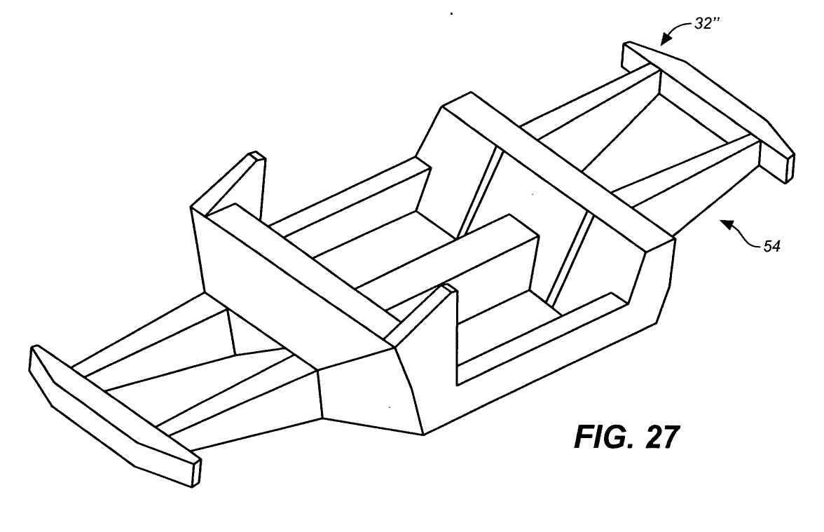

Attention is directed to FIGS. 24-27 illustrating alternative chassis embodiments. The chassis illustrated in these figures are similar to chassis 32 described above and manufactured in substantially the same manner as discussed above. Because of the variations in architecture and application, the combinations of methods of manufacture and particular structures vary from embodiment to embodiment.

In another exemplary embodiment of the present invention, tub module 44h is similar to the various tub modules described but includes integrated rollover protection 117 as shown in FIG. 28. Like reference numerals have been used to describe like components of tub module 44h and those described above.

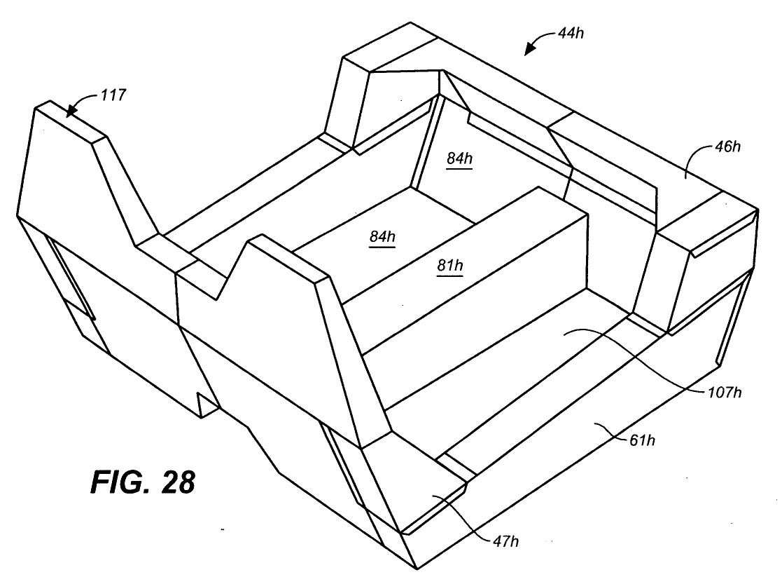

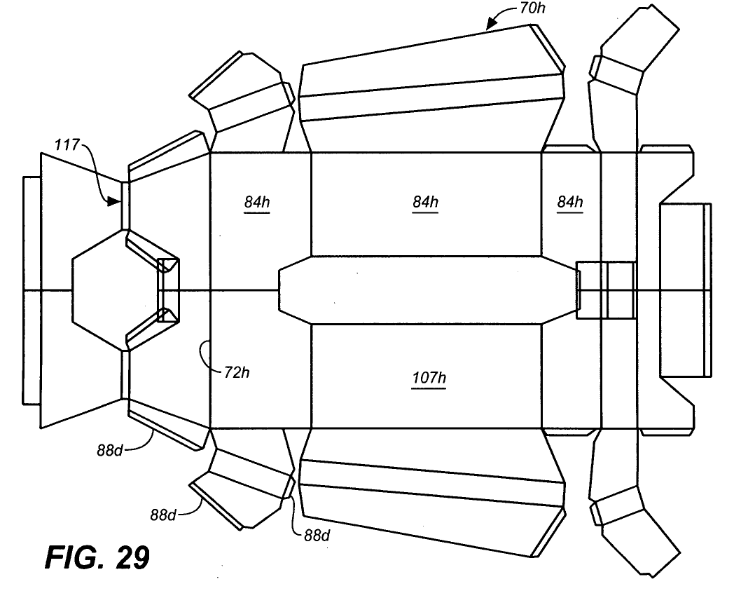

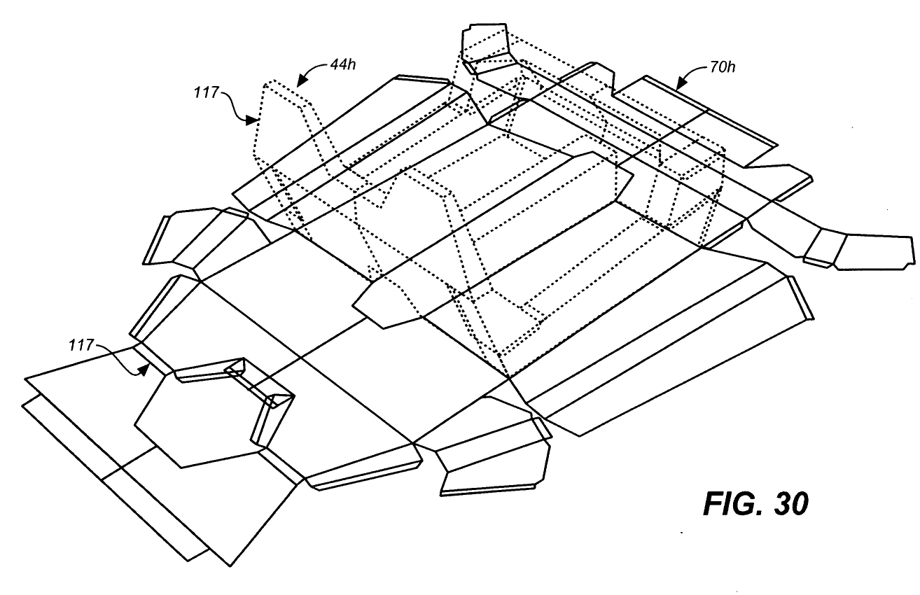

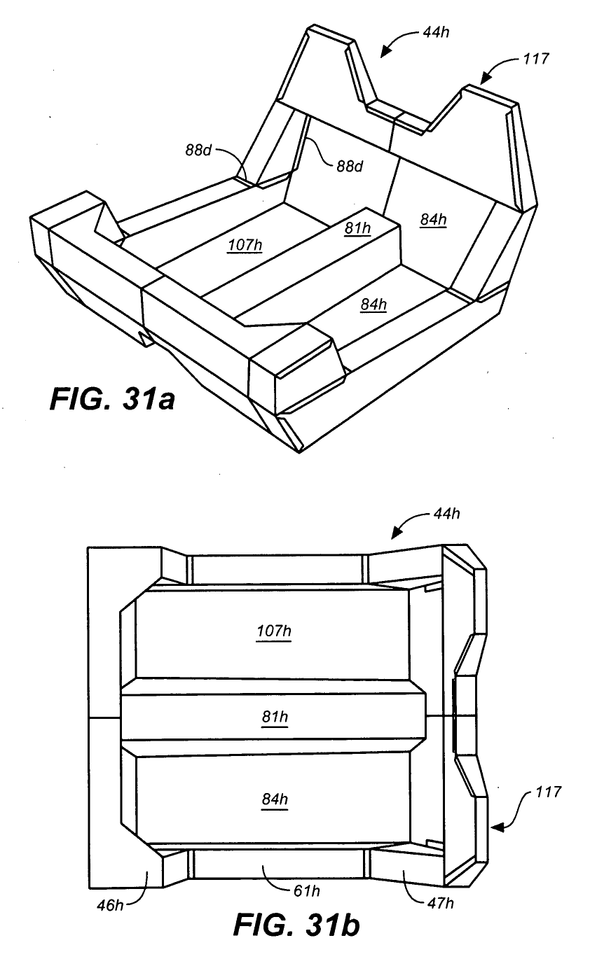

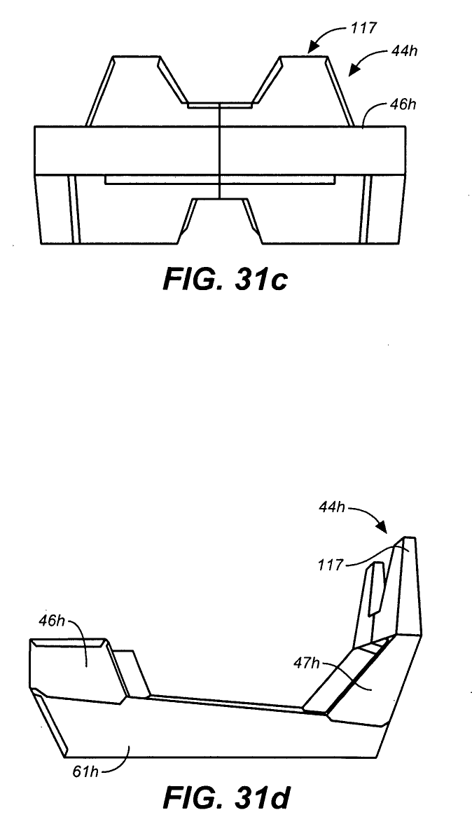

With continued reference to FIG. 28, tub module 44h may be formed from one or more sheets of sheet material. For example, the tub module may be formed from a single sheet material 70h which is shown in FIG. 29. The sheet material includes a number of bend lines 72h configured to facilitate precision bending of the various panels 84h about the bend lines in the manner described above. As in the above described embodiments, the tub module sheet material may be configured to monolithically form a firewall 46h, a bulkhead 47h, rocker beams 61h, and/or other various structural components.

In some embodiments, the tub module may be configured to form a roll protector 117 monolithically formed with bulkhead 47h. In the illustrated embodiment, the protector is in the general shape of a headrest extending upward from bulkhead 47h. One will appreciate, however, that various shapes and geometries may be utilized. Such configuration advantageously simplifies chassis design, contributes to part reduction, and reduces the number of fabrication, joining, and other manufacturing or assembly processes. One will further appreciate that other structural components may be monolithically formed with the tub module such as steering wheel supports, A-pillars, B-pillars, C-pillars and/or other components.

The chassis of the present inventions has many advantages over conventional chassis other than those already discussed. The chassis of the present inventions also allows for easier application of multi-material and multi-architecture designs. The chassis of the present inventions allows for easy integration of several disparate processes and materials into a single, rigid structure. Thus, the chassis architecture of the present inventions may obtain the benefits of multiple chassis types. An exemplary chassis has the rigidity of a monocoque with the flexibility and weight savings of space frame.

The increased flexibility also makes low-volume production possible with complex shapes. The chassis of the present inventions makes efficient use of materials and space. The implementation of hybrid and multi-material applications enabled by the above described features can also lead to weight savings previously not obtainable with single material manufacturing techniques.

The method of manufacturing the chassis of the present inventions has several advantages. The method is less labor intensive, cheaper, makes efficient use of materials, and is faster than conventional techniques. Whereas a conventional chassis manufacturing system may require over thirty welding machines, the chassis of the present inventions may be manufactured by a few workers without complex tools. The assembly process requires little skill relative to conventional chassis manufacturing techniques. In fact, because of the use of precision bending technology, many of the processes can be automated. For example, an exemplary embodiment uses rivets extensively to fasten the chassis. The folding and joining technologies described above may be precise enough to line up the rivet holes with little or no human intervention. The use of bending techniques and simple fasteners like rivets greatly reduces manufacturing time over conventional welding of the entire chassis.

The chassis and methods of the present inventions also allow for natural three-dimensional shape generation through precision curves and geometry enabled by precision folding. Additionally, the chassis can easily be designed and manufactured with a modular architecture. The method of manufacture is enabled, in part, by the inventive design of the chassis in accordance with the present invention.

The chassis of the present inventions achieves significant savings in terms of weight and cost. The methods described above allow for significant parts consolidation and reduction of joints and components. The decreased bill of materials may also lead to higher quality than conventional designs. The chassis of the present inventions allows for consolidation of parts into a single, high-precision, rigid structure.

The chassis of the present inventions also has been found to have significant strength even without the use of large amounts of material. The uniform, joined structure provides optimized load path distribution. This translates into enhanced safety from increased energy absorption.

As will be understood from the preceding, the chassis and method of manufacture in accordance with the present inventions cover many features and processes. Chassis 32 may be formed of a variety of materials utilized and joined in myriad fashion. The method of forming individual components, parts, and assemblies may also vary in accordance with the present inventions as will the method of joining and integration into the overall chassis and vehicle. The exemplary chassis is configured for use in a conventional vehicle system, but chassis in accordance with the present invention may be configured for use in many other systems. Further, the exemplary chassis is configured for a two-door automobile, but may be modified for any vehicle family such as four-door cars, minivans, trucks, rear-wheel-drive, front-wheel-drive, and the like.

Moreover, the chassis of the present inventions may be applied in accordance with the present inventions to many other products and machines including, but not limited to, recreation vehicles, watercraft, land vehicles, motorcycles, farming equipment, construction vehicles, heavy equipment and/or machinery, military vehicles, and other structures for static and dynamic machinery and applications.

For convenience in explanation and accurate definition in the appended claims, the terms “up” or “upper”, “down” or “lower”, “inside” and “outside” and similar terms are used to describe features of the present inventions with reference to the positions of such features as displayed in the figures.

The foregoing descriptions of specific exemplary embodiments of the present inventions have been presented for purposes of illustration and description. They are not intended to be exhaustive or to limit the invention to the precise forms disclosed, and obviously many modifications and variations are possible in light of the above teachings. An exemplary embodiments were chosen and described in order to explain certain principles of the invention and their practical application, to thereby enable others skilled in the art to make and utilize various exemplary embodiments of the present inventions, as well as various alternatives and modifications thereof. It is intended that the scope of the invention be defined by the Claims appended hereto and their equivalents.

1.-9. (canceled)

10. A load-bearing chassis for carrying a body comprising:
a three-dimensional structure formed by a sheet of material including a plurality of bend lines, each bending line having adjacent strap-defining structures defining a bending strap having a longitudinal strap axis oriented and positioned to extend across the bend line;
wherein the bend lines are configured and positioned to form a load-bearing chassis member when the sheet of material is bent along the bend lines, the bend lines defining geometrical features of the chassis.

11. A load-bearing chassis according to claim 10, wherein a portion of the three-dimensional structure is filled with a filler material.

12. A load-bearing chassis according to claim 11, wherein the filler material is expandable foam.

13. A load-bearing chassis according to claim 10, wherein the geometrical features correspond to load paths in the chassis.

14. A method of forming a load-bearing chassis, the method comprising:
preparing a sheet of material having a plurality of bend lines configured and positioned to define a folded three-dimensional geometry, each bend line including a plurality of positioning structures;
bending the sheet of material along the bend lines into a three-dimensional structure;
joining the three-dimensional structure to at least one other structure to form at least a portion of a chassis.

15. The method of claim 14, wherein the positioning structures are strap-defining displacements defining a bending strap having a longitudinal strap axis oriented and positioned to extend obliquely across the bend line.

16. The method of claim 14, wherein, in the preparing step, at least two of the bend lines are configured and positioned such that upon bending the at least two bend lines define a hard geometrical point in the chassis architecture.

17. The method of claim 14, wherein at least one of the bend lines defines one of a hard line or soft inflection in the chassis architecture.

18. The method of claim 17, wherein the at least one bend line is non-linear and defines a boundary between at least two curvilinear panels.

19. The method of claim 14, wherein the other structure to be joined is formed from a folded sheet of material.

20. The method of claim 14, wherein a junction between the three-dimensional structure and at least one other structure defines a hard geometrical boundary in the chassis architecture.

21. The method of claim 19, wherein the junction defines an apex between at least three adjacent panels.

22. The method of claim 21, wherein the junction is configured to produce a smooth transition between the adjacent panels.

23. The method of claim 21, wherein the apex forms a quilted corner of the chassis.

24. The method of claim 14, wherein the chassis is one of an automobile chassis, watercraft chassis, and airplane chassis.

25. The method of claim 24, wherein the chassis is a vehicular chassis and the portion to be formed of the chassis is a longitudinal cross-member structure of a tub forming a vehicle space frame chassis.

26. The method according to claim 25, further including the step of joining a floor panel to the portion of the chassis formed.

27. The method according to claim 26, wherein the floor is a rigid panel including a cellular core sandwiched between film structures.

28. The method according to claim 27, wherein the core is a corrugated sheet.

29. The method according to claim 27, wherein at least one of the three-dimensional structure, other structure, and floor panel are filled with filler material.

30. A method of manufacturing a vehicle comprising:
forming a load-bearing vehicle chassis according to the method of claim 1; and
positioning a body on the chassis.

31. A section of a vehicle chassis comprising:
a first member formed from a folded sheet of material, the sheet of material including a plurality of bend lines, each bending line defined by a plurality of bend-facilitating structures; and
a second member configured for attachment to the first member to form a section of a space frame;
wherein the bend lines are configured and positioned to define a plurality of geometrical features of the resulting chassis section.

32. A section according to claim 31, wherein the first and second member are joined to form a structurally rigid unibody.

33. (canceled)

34. A section of a vehicle chassis comprising:
a three-dimensional structural member formed from a sheet of material, the sheet of material including:
a plurality of bend lines, each bend line having a plurality of bend-facilitating structures; and
a plurality of nodes, each node positioned along one of the plurality of bend lines;
wherein each node defines a geometrical feature of the structure.

35. A section of a vehicle chassis according to claim 34, wherein a junction between at least two of the plurality of bend lines is configured and positioned to define one of the plurality of nodes.

36. (canceled)

37. A support structure for a vehicle body comprising:
a three-dimensional structure formed from a two-dimensional sheet of material, the sheet of material including a plurality of substantially flat panels defined by bend lines, each bend line having a plurality of bend-facilitating structures, wherein at least two non-adjacent panels are rotated along at least two axes relative to each other; and
a rigid structure joined to the three-dimensional structure to form a rigid support structure configured to support a vehicle body.

38. A vehicle including a chassis, the vehicle comprising:
a chassis according to claim 37; and
a body supported by the chassis.

39.-80. (canceled)

81. A load-bearing chassis according to claim 10, wherein at least a portion of the sheet of material comprises:
a control sheet having at least one bend-controlling structure positioned and configured to define the plurality of bend lines in the sheet of material; and
a separate layer of sheet material affixed to the control sheet and configured to bend along the bend lines during bending.

82. A load-bearing chassis according to claim 81, wherein the control sheet and layer of sheet material are adhered together to form a laminate structure.
